(19) United States
(12) Patent Application Publication
(10) Pub. No.: US 2024/0251354 A1
(43) Pub. Date: Jul. 25, 2024

(54) METHOD AND DEVICE FOR ENERGY SAVING IN WIRELESS COMMUNICATION SYSTEM

(71) Applicant: Samsung Electronics Co., Ltd., Gyeonggi-do (KR)

(72) Inventors: Cheolkyu SHIN, Gyeonggi-do (KR); Youngbum KIM, Gyeonggi-do (KR); Junyung YI, Gyeonggi-do (KR); Hyunseok RYU, Gyeonggi-do (KR)

(21) Appl. No.: 18/421,224

(22) Filed: Jan. 24, 2024

(30) Foreign Application Priority Data
Jan. 25, 2023 (KR) 10-2023-0009618

(51) Int. Cl. H04W 52/02

(52) U.S. Cl. CPC H04W 52/0235; H04W 52/0251

(57) ABSTRACT

The disclosure relates to a fifth generation (5G) or sixth generation (6G) communication system for supporting high data transmission rates. Specifically, the disclosure proposes a method and a device for obtaining location related information for a terminal; identifying whether to switch on or switch off a data carrier for network energy saving based on the location related information; and transmitting, to a base station supporting the data carrier, a message including identification information for the terminal and coverage information for the data carrier, based on the identification.

### CROSS-REFERENCE TO RELATED APPLICATION(S)

This application is based on and claims priority under 35 U.S.C. § 119 to Korean Patent Application No. 10-2023-0009618, filed on Jan. 25, 2023, in the Korean Intellectual Property Office, the disclosure of which is herein incorporated by reference in its entirety.

### BACKGROUND

### 1. Field

The disclosure relates generally to a wireless communication system (or mobile communication system). Specifically, the disclosure relates to a method and a device for energy saving or power saving in a wireless communication system.

### 2. Description of Related Art

Fifth generation (5G) mobile communication technologies define broad frequency bands such that high transmission rates and new services are possible, and can be implemented not only in sub sixth generation (6G) gigahertz (GHz) “sub 6 GHz” bands such as 3.5 GHz, but also in “above 6 GHz” bands, referred to as millimeter wave (mmWave), including 28 GHz and 39 GHz. In addition, implementing 6G mobile communication technologies (referred to as beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies has also been considered.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of bandwidth part (BWP), and new channel coding methods (e.g., a low density parity check (LDPC) code for large amounts of data transmission and a polar code for highly reliable transmission of control information), layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN), which is UE-satellite direct communication for providing coverage in an area in which communication with terrestrial networks is unavailable, and positioning technologies.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including a conditional handover and a dual active protocol stack (DAPS) handover, and two-step random access (2-step RACH for NR) for simplifying random access procedures. There also has been ongoing standardization in system architecture/service regarding a 5G baseline architecture (for example, a service based architecture or a service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to additional communication networks. It is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), 5G performance improvement and complexity reduction by utilizing artificial intelligence (AI) and machine learning (ML), AI service support, metaverse service support, and drone communication.

Furthermore, such development of 5G mobile communication systems will serve as a basis for developing new waveforms for providing coverage in THz bands of 6G mobile communication technologies, multi-antenna transmission technologies such as full dimensional MIMO (FD-MIMO), array antennas and large-scale antennas technologies, metamaterial-based lenses and antennas for improving coverage of THz band signals, high-dimensional space multiplexing technology using orbital angular momentum (OAM), and reconfigurable intelligent surface (RIS) technologies, full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The demand for smoothly providing edge services to roaming terminals (e.g., UEs) is increasing and innovative solutions are being sought.

The above information is presented as background information only to assist with an understanding of the disclosure. No determination has been made, and no assertion is made, as to whether any of the above might be applicable as prior art with regard to the disclosure.

### SUMMARY

The present disclosure has been made to address the above-mentioned problems and disadvantages, and to provide at least the advantages described below.

According to an embodiment of the disclosure, a method performed by a first base station supporting an anchor carrier is provided. The method includes obtaining location related information for a terminal; identifying whether to switch on or switch off a data carrier for network energy saving based on the location related information; and transmitting, to a second base station supporting the data carrier, a message including identification information for the terminal and coverage information for the data carrier, based on the identification.

According to another embodiment of the disclosure, a method performed by a second base station supporting a data carrier is provided. The method includes receiving, from a first base station supporting an anchor carrier, a message including identification information for a terminal and coverage information for the data carrier, wherein the message is based on location related information for the terminal; and identifying whether to switch on or switch off the data carrier for network energy saving based on the message.

According to another embodiment of the disclosure, a first base station supporting an anchor carrier is provided. The first base station includes a transceiver; and a controller coupled with the transceiver and configured to obtain location related information for a terminal, identify whether to switch on or switch off a data carrier for network energy saving based on the location related information, and transmit, to a second base station supporting the data carrier, a message including identification information for the terminal and coverage information for the data carrier, based on the identification.

According to another embodiment of the disclosure, a second base station supporting a data carrier is provided. The second base station includes a transceiver; and a controller coupled with the transceiver and configured to receive, from a first base station supporting an anchor carrier, a message including identification information for a terminal and coverage information for the data carrier, wherein the message is based on location related information for the terminal, and identify whether to switch on or switch off the data carrier for network energy saving based on the message.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a basic structure of a time-frequency resource area of a 5G system, according to an embodiment;

FIG. 2 is a diagram illustrating a beam sweeping operation and a time domain mapping structure of a synchronization signal, according to an embodiment;

FIG. 3 is a diagram illustrating a random-access procedure, according to an embodiment;

FIG. 4 is a diagram illustrating a procedure in which a terminal reports UE capability information to a base station, according to an embodiment;

FIG. 5 illustrates a correlation between a frequency band, coverage, and a bandwidth, according to an embodiment;

FIG. 6 illustrates an example of a communication system including an access carrier and a data carrier, according to an embodiment;

FIG. 7 illustrates an example of an operation scenario of the communication system including an access carrier and a data carrier, according to an embodiment;

FIG. 8 illustrates an example of an operation scenario of the communication system including an access carrier and a data carrier, according to an embodiment;

FIG. 9 illustrates an example of an operation scenario of the communication system including an access carrier and a data carrier, according to an embodiment;

FIG. 10 illustrates an example of a scenario of controlling a data carrier based on range, distance and/or direction information of a terminal while performing initial access by the terminal via an access carrier, according to an embodiment;

FIG. 11 illustrates an example of a procedure in which an access carrier controls a data carrier, based on distance and direction information of a terminal, according to an embodiment;

FIG. 12 illustrates an example of a scenario of controlling a data carrier based on coordinate position information of a terminal while performing initial access via an access carrier by the terminal, according to an embodiment;

FIG. 13 illustrates an example of a procedure in which an access carrier controls a data carrier, based on coordinate position information of a terminal, according to an embodiment;

FIGS. 14A-14C illustrate an example of a procedure in which a data carrier to perform one-to-one data communication with a terminal is selected based on position information of the terminal with respect to an access carrier, according to an embodiment;

FIG. 15 illustrates an example of reselecting a data carrier based on a channel quality state of a terminal and a data carrier, according to an embodiment;

FIG. 16 is a block diagram illustrating a terminal, according to an embodiment; and

FIG. 17 is a block diagram illustrating a base station, according to an embodiment.

### DETAILED DESCRIPTION

The disclosure relates to a wireless mobile communication system and, particularly, to a method and a device for network power saving (energy saving) in a wireless communication system. The disclosure proposes various power saving methods via efficient frequency use and base station control.

Hereinafter, embodiments of the disclosure will be described in detail with reference to the accompanying drawings. In describing the disclosure, a detailed description of known functions or configurations incorporated herein may be omitted. In addition, the terms which will be described below are terms defined in consideration of the functions in the disclosure, and may be different according to users, intentions of the users, or customs. Therefore, the definitions of the terms should be made based on the contents throughout the specification.

Various embodiments of the present disclosure are described with reference to the accompanying drawings. However, various embodiments of the present disclosure are not limited to particular embodiments, and it should be understood that modifications, equivalents, and/or alternatives of the embodiments described herein can be variously made. With regard to description of drawings, similar components may be marked by similar reference numerals.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in the embodiments of the disclosure, the term “unit” refers to a software element or a hardware element, such as a field programmable gate array (FPGA) or an application specific integrated circuit (ASIC), which performs a predetermined function. However, the term “unit” does not always have a meaning limited to software or hardware. The term “unit” may be constructed to mean either to be stored in an addressable storage medium or to execute one or more processors. Therefore, the term “unit” includes, for example, software elements, object-oriented software elements, class or task elements, processes, functions, properties, procedures, sub-routines, segments of a program code, drivers, firmware, micro-codes, circuits, data, database, data structures, tables, arrays, and parameters. The elements and functions provided by the term “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the term “unit” in the embodiments may include one or more processors.

In the following description of the disclosure, terms for identifying access nodes, terms referring to network entities, terms referring to messages, terms referring to interfaces between network entities, terms referring to various identification information, and the like may be illustratively used for the sake of descriptive convenience. Therefore, the disclosure is not limited by the terms as used below, and other terms referring to subjects having equivalent technical meanings may be used.

In the following description of the disclosure, terms and names defined in the 3rd generation partnership project (3GPP) long term evolution (LTE) or new radio (NR) standards may be used for the sake of descriptive convenience. However, the disclosure is not limited by these terms and names, and may be applied in the same way to systems that conform other standards.

In the following description, a base station is an entity that allocates resources to terminals, and may be at least one of a radio access network (RAN) node, a next generation node B (gNode B or gNB), an evolved node B (eNode B or eNB), a node B, a wireless access unit, a base station controller, and a node on a network. In the disclosure, the term “eNB” may be interchangeably used with the term “gNB”. That is, a base station described as “eNB” may indicate “gNB”.

In the following description, a terminal may include a UE, a mobile station (MS), a cellular phone, a smartphone, a computer, or a multimedia system capable of performing communication functions. Examples of the base station and the terminal are not limited thereto.

In the following description, the terms “physical channel” and “signal” may be interchangeably used with the term “data” or “control signal”. For example, a physical downlink shared channel (PDSCH) is a term referring to a physical channel over which data is transmitted, but the PDSCH may be used to refer to data. That is, in the disclosure, the expression “transmit a physical channel” may be construed as having the same meaning as “transmit data or a signal over a physical channel”.

In the following description of the disclosure, higher signaling (or higher-layer signaling) may mean a signal transmission method in which a base station transmits a signal to an electronic device by using a downlink data channel in a physical layer or an electronic device transmits a signal to a base station by using an uplink data channel in a physical layer. The higher signaling may be understood as radio resource control (RRC) signaling or a media access control (MAC) control element (CE).

In the following description of the disclosure, terms and names defined in the 3GPP NR: 5th generation mobile communication standards may be used for the sake of descriptive convenience. However, the disclosure is not limited by these terms and names, and may be applied in the same way to systems that conform other standards.

Furthermore, the term “terminal” may refer to not only UEs, mobile phones, smart phones, Internet of things (IOT) devices, and sensors, but also other wireless communication devices.

In order to handle the recent explosive increase in mobile data traffic, initial standards for a 5G system or NR access technology, which is a communication system after LTE or evolved universal terrestrial radio access (E-UTRA), and LTE-advanced (LTE-A) or E-UTRA evolution, has been completed. Along with this, discussions on a 6G system that is a next-generation communication system are beginning. While mobile communication systems focus on general voice/data communication, 5G and 6G systems aim at meeting requirements and various services, such as eMBB service for enhancement of the voice/data communications, a URLLC service, and an mMTC service supporting massive IoT communication.

While a system transmission bandwidth per single-carrier of LTE and LTE-A may be limited to a maximum of 20 MHz, 5G and 6G systems mainly aim at a high-speed data service reaching several gigabits per second (Gbps) by using a significantly wider ultra-wide bandwidth. Accordingly, the 5G and 6G systems consider, as candidate frequencies, ultra-high frequency bands from several GHz to up to 100 GHz in which it is relatively easy to secure ultra-wide bandwidth frequencies. Additionally, it is possible to secure wide bandwidth frequencies for the 5G and 6G systems via frequency rearrangement or allocation among frequency bands ranging from hundreds of MHz to several GHz used in the mobile communication systems.

A radio wave in the ultra-high frequency band has a wavelength of several millimeters (mm) and is also referred to as a mmWave. However, in the ultra-high frequency band, a path loss of radio waves increases in proportion to a frequency band, and thus a coverage range of a mobile communication system is reduced.

In order to overcome the disadvantage of reduction in coverage in the ultra-high frequency band, a beamforming technology is applied to increase a radio wave arrival distance by concentrating a radiation energy of radio waves on a certain target point by using multiple antennas. In other words, a signal to which the beamforming technology is applied has a relatively narrow beam width, and radiation energy is concentrated within the narrow beam width, so that the radio wave arrival distance increases. The beamforming technology may be applied to each of a transmission end and a reception end. In addition to increasing of the coverage range, the beamforming technology also has an effect of reducing interference in an area other than a beamforming direction. In order for the beamforming technology to properly operate, an accurate transmission/reception beam measurement and feedback method is required. The beamforming technology may be applied to a control channel or a data channel having a one-to-one correspondence between a certain terminal and a base station. In addition, to increase coverage, the beamforming technology may also be applied to a control channel and a data channel, via which a base station transmits a common signal, such as a synchronization signal, a physical broadcast channel (PBCH), and system information, to multiple terminals in a system. When the beamforming technology is applied to a common signal, a beam sweeping technique for transmitting a signal by changing a beam direction is additionally applied to allow the common signal to reach a terminal located at any position within a cell.

In addition, for the 5G and 6G systems, an ultra-low latency service with a transmission delay of approximately 1 ms between a transmission end and a reception end may be required. As a method for reducing a transmission delay, a frame structure based on a short transmission time interval (TTI) compared to that in LTE and LTE-A should be designed. A TTI is a basic time unit for performing scheduling, and a TTI in LTE and LTE-A systems is 1 ms which corresponds to a length of one subframe. For example, as a short TTI for satisfying requirements for the ultra-low latency service in the 5G and 6G systems, TTIs of 0.5 ms, 0.25 ms, 0.125 ms, etc. which are shorter than those of the LTE and LTE-A systems are possible.

As an example of a commercial 5G base station, the base station may be equipped with 64 transmission antennas and 64 corresponding power amplifiers in a 3.5 GHZ frequency band and may operate with a bandwidth of 100 MHZ. Accordingly, energy consumption of the base station increases in proportion to the outputs and operation time of the power amplifiers. When compared to an LTE base station, the 5G base station has a relatively high operating frequency band so as to have a wide bandwidth and a large number of transmission antennas. According to this, while a data rate can be increased, the cost due to increased energy consumption of the base station occurs. Therefore, as there are more base stations constituting a network in 5G and 6G systems, energy consumption of the entire mobile communication network increases in proportion thereto. Accordingly, a method for reducing energy consumption of the base station needs to be considered.

In the disclosure, an “access carrier” and a “data carrier” are distinguished, and a method of adaptively adjusting a transmission power of the data carrier is proposed. In the disclosure, it is noted that the terms of access carrier and data carrier may be replaced with other terms indicating similar functions. In the proposed embodiment, the access carrier may control initial access of a terminal, identify a position of the terminal to select a data carrier suitable for the terminal during the control of the initial access, and provide relevant information to the data carrier so as to enable the data carrier to adjust a transmission power. However, because such a method of selecting a data carrier by using position information of a terminal does not reflect a link and a channel state between the data carrier and the terminal, it may be necessary, as a follow-up measure, to reselect a data carrier by identifying a link and a channel state between the data carrier and the terminal. In the disclosure, information exchange and procedures enabling the described operations are proposed. Based on the method proposed in the disclosure, it is possible to adaptively adjust a transmission power of a data carrier, thereby reducing network energy consumption.

Embodiments of the disclosure are proposed to support the scenario described above, and provide a method and a device for reducing energy consumption of a base station and efficiently using frequency in a mobile communication system.

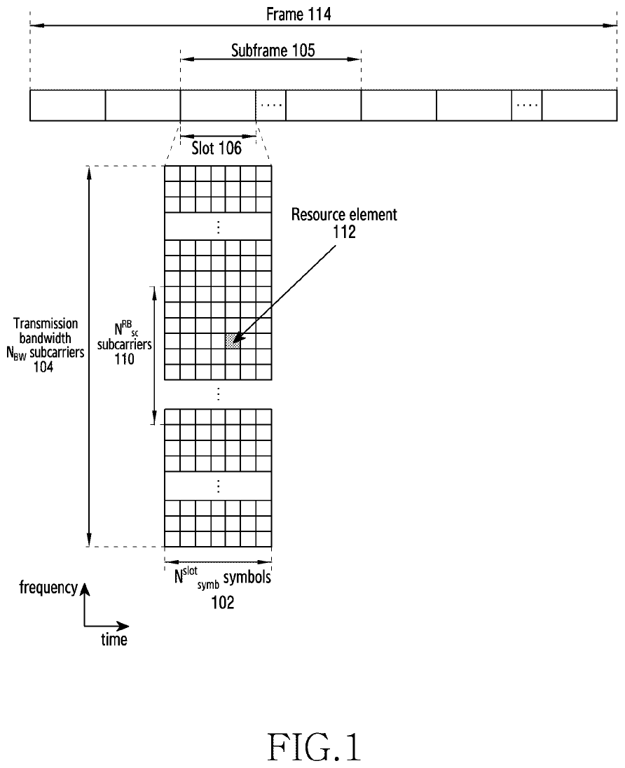

FIG. 1 is a diagram illustrating a basic structure of a time-frequency resource area of a 5G system, according to an embodiment. More specifically, FIG. 1 illustrates a basic structure of a time-frequency resource area that is a radio resource area in which a data or control channel is transmitted in the 5G system, and the same structure may be considered in a 6G system. However, in the 6G system, it is noted that the disclosure is not limited to the structure of the time-frequency resource area of FIG. 1.

Referring to FIG. 1, the horizontal axis represents a time domain and the vertical axis represents a frequency domain. A minimum transmission unit in the time domain of the 5G system is an orthogonal frequency division multiplexing (OFDM) symbol, wherein N_{symb}^{slot} symbols 102 are gathered to constitute one slot 106, and Nₛₗₒₜ^{subframe} slots are gathered to constitute one subframe 105. A length of one subframe 105 may be 1.0 ms, and 10 subframes may be gathered to constitute a frame 114 of 10 ms. A minimum transmission unit in a frequency domain is a subcarrier, and a bandwidth of the entire system transmission bandwidth may include a total of N_{BW} subcarriers 104.

A basic unit of resources in the time-frequency domain is a resource element (RE) 112, and may be represented by an OFDM symbol index and a subcarrier index. A resource block (RB) (or a physical RB (PRB)) may be defined to be N_{sc}^{RB} consecutive subcarriers 110 in the frequency domain. In the 5G system, N_{sc}^{RB}=12, and a data rate may increase in proportion to the number of RBs scheduled for a terminal.

In the 5G system, a base station may map data in units of RBs and may generally perform scheduling on RBs constituting one slot for a certain terminal. That is, in the 5G system, a basic time unit in which scheduling is performed may be a slot, and a basic frequency unit in which scheduling is performed may be an RB.

The number of OFDM symbols, N_{symb}^{slot} is determined according to a length of a cyclic prefix (CP) which is added to each symbol to prevent interference between symbols, and for example, NN_{symb}^{slot}=14 when a normal CP is applied, and N_{symb}^{slot}=12 when an extended CP is applied. The extended CP is applied to a system having a relatively long radio wave transmission distance compared to the normal CP, so as to enable orthogonality between symbols to be maintained. For the normal CP, a ratio between a CP length and a symbol length is maintained at a constant value, so that an overhead due to the CP may be maintained constant regardless of a subcarrier spacing. That is, if a subcarrier spacing is small, a symbol length becomes longer, and a CP length may also become longer accordingly. On the other hand, if a subcarrier spacing is large, a symbol length becomes shorter, and a CP length may be reduced accordingly. A symbol length and a CP length may be inversely proportional to a subcarrier spacing.

In the 5G system, in order to satisfy various services and requirements, various frame structures may be supported by adjusting a subcarrier spacing. For example, in terms of an operating frequency band, as a subcarrier spacing becomes greater, it is more advantageous to recover from phase noise in a high frequency band. In terms of a transmission time, as a subcarrier spacing becomes greater, a symbol length in the time domain becomes shorter, and as a result, a slot length becomes shorter and it is thus advantageous to support an ultra-low latency service, such as URLLC. In terms of a cell size, since a larger cell is supportable as a CP length becomes longer, a relatively larger cell is supportable as a subcarrier spacing becomes smaller. In mobile communication, a cell is a concept that refers to an area covered by a single base station.

A subcarrier spacing, a CP length, etc., are information for OFDM transmission and reception, and smooth transmission and reception is possible when a base station and a terminal recognize a subcarrier spacing, a CP length, etc. as common values. Table 1, below, shows a relationship between subcarrier spacing configuration μ, subcarrier spacing Δf, and a CP length supported in the 5G system.

TABLE 1

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Table 2, below, shows the number (N_{symb}^{slot}) of symbols per slot, the number (Nₛₗₒₜ^{frame,μ}) of slots per frame, and the number (Nₛₗₒₜ^{subframe,μ}) of slots per subframe for each subcarrier spacing configuration (μ) for a normal CP.

TABLE 2

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3, below, shows the number (N_{symb}^{slot}) of symbols per slot, the number (Nₛₗₒₜ^{frame,μ}) of slots per frame, and the number (Nₛₗₒₜ^{subframe,μ}) of slots per subframe for each subcarrier spacing configuration (μ) for an extended CP.

TABLE 3

| μ | N_{symb}^{slot} | Nₛₗₒₜ^{frame, μ} | Nₛₗₒₜ^{subframe, μ} |
|---|---|---|---|
| 2 | 12 | 40 | 4 |

Coexistence or dual mode operation with the LTE and LTE-A systems (hereinafter, LTE/LTE-A) may be expected. Accordingly, the LTE/LTE-A may provide a stable system operation to terminals, and the 5G system may serve to provide an enhanced service to terminals. Therefore, the frame structure of the 5G system should include at least a frame structure or an essential parameter set (e.g., subcarrier spacing=15 kHz) of LTE/LTE-A.

For example, when comparing a frame structure (hereinafter, frame structure A) in which subcarrier spacing configuration μ=0 with a frame structure (hereinafter, frame structure B) in which subcarrier spacing configuration μ=1, frame structure B has twice the subcarrier spacing and RB size, and has half the slot length and symbol length, as frame structure A. For frame structure B, 2 slots may constitute 1 subframe, and 20 subframes may constitute 1 frame.

When the frame structure of the 5G system is generalized, high scalability may be provided by making a subcarrier spacing, a CP length, a slot length, etc., which are included in the essential parameter set, have a relationship of an integer multiple to each other for each frame structure. In addition, a subframe having a fixed length of 1 ms may be defined to indicate a reference time unit irrelevant to the frame structure.

The frame structure of the 5G system may be adapted and applied to various scenarios. In terms of a cell size, since a larger cell is supportable as a CP length becomes longer, frame structure A is able to support a relatively larger cell compared to frame structure B. In terms of an operating frequency band, as a subcarrier spacing becomes greater, it is more advantageous to recover from phase noise in a high frequency band, so that frame structure B is able to support a relatively higher operating frequency compared to frame structure A. In terms of a service, to support an ultra-low latency service such as URLLC, it is more advantageous for a slot length, which is the basic time unit of scheduling, to be short so that frame structure B may be more appropriate to use with an URLLC service compared to frame structure A.

In the following description of the disclosure, uplink may refer to a wireless link via which a terminal transmits a data or control signal to a base station, and downlink may refer to a wireless link via which a base station transmits a data or control signal to a terminal.

During initial access of a terminal accessing the system for a first time, the terminal may, via a cell search, synchronize a downlink time and frequency from a synchronization signal transmitted by a base station and acquire a cell identifier (ID). In addition, the terminal may receive, using the acquired cell ID, a PBCH and acquire a master information block (MIB) which is essential system information from the PBCH. Additionally, the terminal may receive a system information block (SIB) transmitted by the base station to acquire cell-common transmission and reception-related control information. The cell-common transmission and reception-related control information may include random-access-related control information, paging-related control information, and common control information for various physical channels.

The synchronization signal may be a signal that serves as a reference for a cell search, and for each frequency band, a subcarrier spacing may be applied to the synchronization signal so as to be suitable for a channel environment, such as phase noise. For a data channel or a control channel, in order to support various services as described above, a subcarrier spacing may be applied differently depending on a service type.

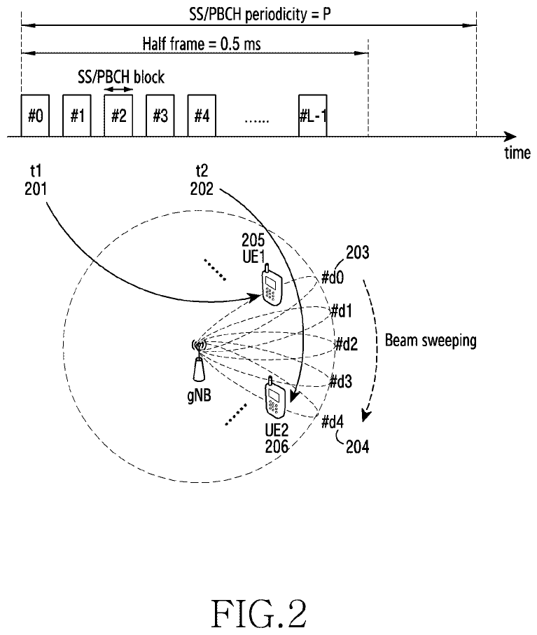

FIG. 2 is a diagram illustrating a beam sweeping operation and a time domain mapping structure of a synchronization signal, according to an embodiment. The same structure may also be considered in the 6G system. However, in the 6G system, it is noted that the disclosure is not limited to the beam sweeping structure and the time domain mapping structure of the synchronization signal of FIG. 2.

For the description of FIG. 2, primary synchronization signal (PSS) may be a signal that serves as a reference for downlink time/frequency synchronization, and provides some of cell ID information; secondary synchronization signal (SSS) may be a signal that serves as a reference for downlink time/frequency synchronization, and provides some of the remaining cell ID information (additionally, the SSS may serve as a reference signal for demodulation of a PBCH); and a PBCH may provide an MIB which is essential system information required for transmission and reception of a data channel and a control channel of a terminal. The MIB may include search space-related control information indicating radio resource mapping information of a control channel, scheduling control information for a separate data channel for transmission of the system information, and information such as a system frame number (SFN) which is a frame unit index that serves as a timing reference.

In addition, for the description of FIG. 2, a synchronization signal/PBCH block (an SSB or SS/PBCH block) may be configured by N OFDM symbols and may include a combination of a PSS, an SSS, a PBCH, etc. For a system to which a beam sweeping technology is applied, an SS/PBCH block is a minimum unit to which beam sweeping is applied.

In the 5G system, N may equal 4 (N=4). A base station may transmit up to L SS/PBCH blocks, and the L SS/PBCH blocks are mapped within a half frame (0.5 ms). In addition, the L SS/PBCH blocks are periodically repeated in each predetermined period P. The base station may inform a terminal of period P via signaling. If there is no separate signaling for period P, the terminal may apply a previously agreed upon default value. The respective SS/PBCH blocks have SS/PBCH block indexes from 0 to up to L-1, and the terminal may have knowledge of the SS/PBCH block indexes via SS/PBCH detection.

Referring to FIG. 2, beam sweeping is applied in units of SS/PBCH blocks over time. In FIG. 2, UE (terminal) 1 205 receives an SS/PBCH block by using a beam emitted in direction #d0 203, by beamforming applied to SS/PBCH block #0 at time point t1. In addition, UE (terminal) 2 206 receives an SS/PBCH block by using a beam emitted in direction #d4 204, by beamforming applied to SS/PBCH block #4 at time point t2. The terminal may acquire, from the base station, an optimal synchronization signal via a beam emitted in a direction where the terminal is located. For example, it may be difficult for terminal 1 205 to acquire time/frequency synchronization and essential system information from the SS/PBCH block via the beam emitted in direction #d4 which is far from the position of terminal 1.

In addition to the initial access, in order to determine whether a radio link quality of a current cell is maintained at a certain level or higher, the terminal may receive an SS/PBCH block. In addition, during a handover in which the terminal moves access from the current cell to an adjacent cell, the terminal may determine a radio link quality of the adjacent cell and receive an SS/PBCH block of the adjacent cell to acquire time/frequency synchronization of the adjacent cell.

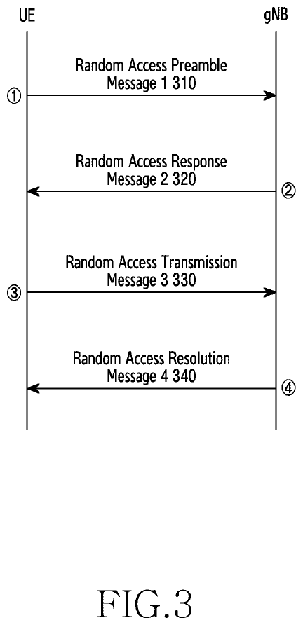

After the terminal acquires the MIB and system information via the initial access, the terminal may perform random access for switching a link to the base station to a connected state (or RRC_CONNECTED state). When the random access is completed, the terminal is switched to the connected state, and one-to-one communication becomes possible between the base station and the terminal. The random access will be described in detail below with reference to FIG. 3.

FIG. 3 is a diagram illustrating a random-access procedure, according to an embodiment. The same structure may also be considered in the 6G system. However, in the 6G system, it is noted that the disclosure is not limited to the random-access procedure of FIG. 3.

Referring to FIG. 3, as a first operation 310 for random access, a UE (terminal) transmits a random-access preamble to a base station. The random-access preamble is a first transmission message of the terminal in the random access and may be referred to as message 1. The base station may measure a transmission delay value between the terminal and the base station from the random-access preamble, and may adjust uplink synchronization. In this case, the terminal may randomly select which random-access preamble to use within a random-access preamble set given in advance by system information. In addition, an initial transmission power of the random-access preamble may be determined according to a path loss between the base station and the terminal, which is measured by the terminal. Also, the terminal may transmit the random-access preamble by determining a transmission beam direction of the random-access preamble from a synchronization signal received from the base station.

In a second operation 320, the base station transmits an uplink transmission timing adjustment command to the terminal, based on the transmission delay value measured from the random-access preamble received in the first operation 310. In addition, the base station may transmit, as scheduling information, a power control command and an uplink resource to be used by the terminal. The scheduling information may include control information on an uplink transmission beam of the terminal.

If the terminal fails, in the second operation 320, to receive a random-access response (RAR) (or message 2) including scheduling information for message 3 from the base station within a predetermined time, the terminal may perform the first operation 310 again. If the terminal performs the first operation 310 again, the terminal may perform transmission by increasing the transmission power of the random-access preamble by a predetermined step (e.g., power ramping), so as to increase a probability of the base station receiving the random-access preamble.

In a third operation 330, the terminal transmits, to the base station, uplink data (message 3) including a terminal ID of the terminal itself via an uplink data channel (a physical uplink shared channel (PUSCH)) by using the uplink resource allocated in the second operation 320. Transmission timing of the uplink data channel for transmitting message 3 may follow the timing control command received from the base station in the second operation 320. In addition, the transmission power of the uplink data channel for transmitting message 3 may be determined by considering a power ramping value of the random-access preamble and the power control/adjustment command received from the base station in the second operation 320. The uplink data channel for transmitting message 3 may refer to a first uplink data signal transmitted by the terminal to the base station after the terminal transmits the random-access preamble.

In a fourth operation 340, when it is determined that the terminal has performed random access without a collision with another terminal, the base station transmits, to the terminal, data (message 4) including the ID of the terminal having transmitted the uplink data in the third operation 330. When the signal transmitted by the base station in the fourth operation 340 is received from the base station, the terminal may determine that random access has been successful. In addition, the terminal may transmit, to the base station via an uplink control channel (a physical uplink control channel (PUCCH)), hybrid automatic repeat request (HARQ)-acknowledgment (ACK) information indicating successful reception of message 4.

If the data transmitted by the terminal in the third operation 330 collides with the data of another terminal, and the base station fails to receive the data signal from the terminal, the base station may no longer transmit data to the terminal. Accordingly, if the terminal fails to receive the data transmitted in the fourth operation 340 from the base station within a certain time, the terminal may determine that random access has failed, and restart from the first operation 310.

When the random access is successfully completed, the terminal is switched to the connected state, and one-to-one communication becomes possible between the base station and the terminal. The base station may receive a report of UE capability or capability information from the terminal in the connected state, and adjust scheduling by referring to the UE capability information of the terminal. The terminal may inform, via the UE capability information, the base station of whether the terminal itself supports a certain function, a maximum allowable value of the function supported by the terminal, etc. Therefore, UE capability information that each terminal reports to the base station may have a different value for each terminal.

For example, the terminal may report, as the UE capability information to the base station, UE capability information including at least part control information related to a frequency band supported by the terminal; related to a channel bandwidth supported by the terminal; related to a maximum modulation scheme supported by the terminal; related to a maximum number of beams supported by the terminal; related to a maximum number of layers supported by the terminal; related to CSI reporting supported by the terminal; control information on whether the terminal supports frequency hopping; bandwidth-related control information when carrier aggregation (CA) is supported; and/or control information on whether cross carrier scheduling is supported when carrier aggregation is supported.

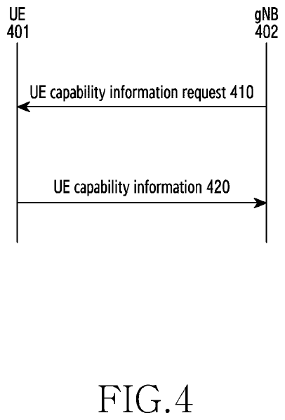

FIG. 4 is a diagram illustrating a procedure in which a terminal reports UE capability information to a base station, according to an embodiment of the disclosure.

Referring to FIG. 4, in operation 410, a base station 402 may transmit a UE capability information request message to a UE (terminal) 401. In response to the UE capability information request of the base station, the terminal transmits UE capability to the base station in operation 420.

Hereinafter, a description will be provided for a scheduling method in which the base station transmits downlink data to the terminal or indicates for the terminal to transmit uplink data.

Downlink control information (DCI) is control information that a base station transmits to a terminal via a downlink, and may include downlink data scheduling information or uplink data scheduling information for a predetermined terminal. In general, a base station may independently channel-code DCI for each terminal and then transmit the same to each terminal via a physical downlink control channel (PDCCH) that is a downlink physical control channel.

For scheduling by the terminal, the base station may perform an operation by applying a predetermined DCI format according to a purpose, such as whether scheduling information is for downlink data (downlink assignment), whether scheduling information is for uplink data (uplink grant), and/or whether DCI is for power control.

The base station may transmit downlink data to the terminal via a PDSCH that is a physical channel for downlink data transmission. Scheduling information, such as power control information, HARQ-related control information, a modulation scheme, and a specific mapping position in the time and frequency domains of a PDSCH may be provided to the terminal by the base station via DCI related to downlink data scheduling information in the DCI transmitted via a PDCCH.

The terminal may transmit uplink data to the base station via a PUSCH that is a physical channel for uplink data transmission. Scheduling information, such as power control/adjustment information, HARQ-related control information, a modulation scheme, and a specific mapping position in the time and frequency domains of the PUSCH may be provided to the terminal by the base station via DCI related to uplink data scheduling information in the DCI transmitted via the PDCCH.

Time-frequency resources to which a PDCCH is mapped is referred to as a control resource set (CORESET). A CORESET may be configured on all or some of frequency resources of a bandwidth supported by the terminal in the frequency domain. One or multiple OFDM symbols may be configured in the time domain, and may be defined to be a CORESET duration. The base station may configure one or multiple CORESETs for the terminal via higher-layer signaling (e.g., system information, MIB, or RRC signaling). Configuring a CORESET for the terminal may refer to providing information, such as a CORESET ID (identity), a frequency position of the CORESET, and a symbol length of the CORESET. The information provided to the terminal by the base station to configure a CORESET may include at least some of information included in Table 4.

TABLE 4

| | |
|---|---|
| ControlResourceSet ::= | SEQUENCE { |
| controlResourceSetId | ControlResourceSetId, |

(CORESET identity)

| | |
|---|---|
| frequency DomainResources | BIT STRING (SIZE (45)), |

(Frequency domain resource)

| | |
|---|---|
| duration | INTEGER |

(1..maxCoReSetDuration),
(CORESET duration)

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, n6}, |

(REG bundle size)

| | |
|---|---|
| interleaverSize | ENUMERATED {n2, n3, n6}, |

```
            (Interleaver size)
            shiftIndex
```

| | |
|---|---|
| INTEGER(0..maxNrofPhysicalResourceBlocks−1) | OPTIONAL -- Need S |

```
            (Interleaver shift)
        },
```

| | |
|---|---|
| nonInterleaved | NULL |

},

| | |
|---|---|
| precoderGranularity | ENUMERATED {sameAsREG-bundle, |

allContiguousRBs},
(Precoding unit)

| | |
|---|---|
| tci-StatesPDCCH-ToAddList | SEQUENCE(SIZE (1..maxNrofTCI- |

StatesPDCCH)) OF TCI-StateId OPTIONAL, -- Cond NotSIB1-initialBWP
(QCL configuration information)

| | |
|---|---|
| tci-StatesPDCCH-ToReleaseList | SEQUENCE(SIZE (1..maxNrofTCI- |

StatesPDCCH)) OF TCI-StateId OPTIONAL, -- Cond NotSIB1-initialBWP
(QCL configuration information)

| | |
|---|---|
| tci-PresentInDCI | ENUMERATED {enabled} |

OPTIONAL, -- Need S
(QCL indicator configuration information in DCI)

| | |
|---|---|
| pdcch-DMRS-ScramblingID | INTEGER (0..65535) |

```
OPTIONAL, -- Need S
      (PDCCH DMRS scrambling identifier)
    }
```

A CORESET may include N_{RB}^{CORESET} RBs in the frequency domain, and may include N_{SYMB}^{CORESET}∈{1, 2, 3} symbols in the time domain. An NR PDCCH may include one or multiple control channel elements (CCEs). One CCE may include 6 resource element groups (REGs), and an REG may be defined to be one RB during one OFDM symbol. In one CORESET, REGs may be indexed in a time-first order starting with REG index 0 from a first OFDM symbol, a lowest RB, of the CORESET.

As a transmission method for a PDCCH, such as an interleaved scheme and a non-interleaved scheme may be supported. The base station may configure, for the terminal via higher-layer signaling, whether to perform interleaved or non-interleaved transmission for each CORESET. Interleaving may be performed in units of REG bundles. An REG bundle may be defined to be a set of one or multiple REGs. The terminal may determine a CCE-to-REG mapping scheme in a corresponding CORESET in the manner as shown in Table 5, below, depending on the interleaved or non-interleaved transmission configured from the base station.

```
TABLE 5
  The CCE-to-REG mapping for a control-resource set can be interleaved or non-
interleaved and is described by REG bundles:
  - REG bundle i is defined as REGs {iL, iL + 1,..., iL + L − 1} where L is the
REG bundle size, i = 0,1, ..., N_{REG}^{CORESET}/L − 1, and N_{REG}^{CORESET} = N_{RB}^{CORESET} N_{symb}^{CORESET}
is the number of REGs in the CORESET
  - CCE j consists of REG bundles {f(6j/L), f(6j/L + 1),..., f(6j/L + 6/L −
1)} where f(·)is an interleaver
  For non-interleaved CCE-to-REG mapping, L = 6 and f(x) = x.
  For interleaved CCE-to-REG mapping, L ∈ {2,6}for N_{symb}^{CORESET} = 1 and L ∈
{N_{symb}^{CORESET},6} for N_{symb}^{CORESET} ∈ {2,3}. The interleaver is defined by
```

```
f(x) = (rC + c + n_{shift}) mod (N_{REG}^{CORESET}/L)
      x = cR + r
    r = 0,1,..., R − 1
    c = 0,1,..., C − 1
  C = N_{REG}^{CORESET}/(LR)
```

where R ∈ = {2,3,6}.

The base station may inform the terminal of configuration information, such as a symbol, to which a PDCCH is mapped, in a slot and a transmission period, via signaling.

A search space of the PDCCH is described as follows. The number of CCEs required to transmit the PDCCH may be 1, 2, 4, 8, or 16 depending on an aggregation level (AL), and different numbers of CCEs may be used for link adaptation of the downlink control channel. For example, if AL=L, a single downlink control channel may be transmitted via L CCEs. The terminal performs blind decoding to detect a signal without knowing information on the downlink control channel, and a search space indicating a set of CCEs is defined for blind decoding. A search space is a set of downlink control channel candidates including CCEs, for which the terminal needs to attempt decoding on a given aggregation level, and since there are various aggregation levels that make one bundle with 1, 2, 4, 8, or 16 CCEs, the terminal may have multiple search spaces. The search space set may be defined to be a set of search spaces at all configured aggregation levels.

A search space may be classified into a common search space (CSS) and a terminal-specific (UE-specific) search space (USS). A certain group of terminals or all terminals may monitor a common search space of the PDCCH to receive cell-common control information, such as a paging message or dynamic scheduling for system information (SIB). For example, the terminal may receive PDSCH scheduling assignment information for system information reception, by monitoring the common search space of the PDCCH. Since a certain group of terminals or all terminals need to receive the PDCCH, the common search space may be defined to be a set of predetermined CCEs. Scheduling assignment information for a UE-specific PDSCH or PUSCH may be received by monitoring a UE-specific search space of the PDCCH. The UE-specific search space may be defined UE-specifically, based on an identity of the terminal and functions of various system parameters.

The base station may configure configuration information on the search space of the PDCCH for the terminal via higher-layer signaling (e.g., SIB, MIB, or RRC signaling). For example, the base station may configure, for the terminal, the number of PDCCH candidates at each aggregation level L, a monitoring period for a search space, a monitoring occasion per symbol in a slot for the search space, a search space type (common search space or UE-specific search space), a combination of a radio network temporary identifier (RNTI) and a DCI format, which is to be monitored in the search space, and/or a CORESET index for monitoring of the search space, etc. For example, parameters for the search space for the PDCCH may include the following information as shown below in Table 6.

TABLE 6

| | |
|---|---|
| SearchSpace ::= | SEQUENCE { |
| searchSpaceId | SearchSpaceId, |

(Search space identity)

| | |
|---|---|
| controlResourceSetId | ControlResourceSetId |

```
OPTIONAL, -- Cond SetupOnly
      (CORESET identity)
    monitoringSlotPeriodicityAndOffset CHOICE {
      (Monitoring slot level period and offset)
```

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559) |

}
OPTIONAL, -- Cond Setup

| | |
|---|---|
| duration | INTEGER (2..2559) |

OPTIONAL, -- Need R
(Monitoring duration)

| | |
|---|---|
| monitoringSymbolsWithinSlot | BIT STRING (SIZE (14)) |

OPTIONAL, -- Cond Setup
(Monitoring symbol location in slot)

| | |
|---|---|
| nrofCandidates | SEQUENCE { |

(The number of PDCCH candidates for each aggregation level)

| | |
|---|---|
| aggregationLevel1 | ENUMERATED {n0, n1, n2, n3, |

n4, n5, n6, n8},

| | |
|---|---|
| aggregationLevel2 | ENUMERATED {n0, n1, n2, n3, |

n4, n5, n6, n8},

| | |
|---|---|
| aggregationLevel4 | ENUMERATED {n0, n1, n2, n3, |

n4, n5, n6, n8},

| | |
|---|---|
| aggregationLevel8 | ENUMERATED {n0, n1, n2, n3, |

n4, n5, n6, n8},

| | |
|---|---|
| aggregationLevel16 | ENUMERATED {n0, n1, n2, n3, |

n4, n5, n6, n8}
}
OPTIONAL, -- Cond Setup

| | |
|---|---|
| searchSpaceType | CHOICE { |

(Search space type)

| | |
|---|---|
| common | SEQUENCE { |

(Common search space)

| | |
|---|---|
| dci-Format0-0-AndFormat1-0 | SEQUENCE { |

```
            ...
          }
OPTIONAL, -- Need R
```

| | |
|---|---|
| dci-Format2-0 | SEQUENCE { |
| nrofCandidates-SFI | SEQUENCE { |

```
                          aggregationLevel1
ENUMERATED {n1, n2} OPTIONAL, -- Need R
                          aggregationLevel2
ENUMERATED {n1, n2} OPTIONAL, -- Need R
                          aggregationLevel4
ENUMERATED {n1, n2} OPTIONAL, -- Need R
                          aggregationLevel8
ENUMERATED {n1, n2} OPTIONAL, -- Need R
                          aggregationLevel16
ENUMERATED {n1, n2} OPTIONAL  -- Need R
            },
            ...
```

| | |
|---|---|
| } | OPTIONAL, |

-- Need R

| | |
|---|---|
| dci-Format2-1 | SEQUENCE { |

```
            ...
          }
OPTIONAL, -- Need R
```

| | |
|---|---|
| dci-Format2-2 | SEQUENCE { |

...

| | |
|---|---|
| } | OPTIONAL, |

-- Need R

| | |
|---|---|
| dci-Format2-3 | SEQUENCE { |

```
            dummy1
ENUMERATED {sl1, sl2, sl4, sl5, sl8, sl10, sl16, sl20} OPTIONAL, -- Cond Setup
            dummy2
ENUMERATED {n1, n2},
            ...
          }
OPTIONAL -- Need R
        },
```

| | |
|---|---|
| ue-Specific | SEQUENCE { |

(UE-specific search space)

| | |
|---|---|
| dci-Formats | ENUMERATED |

```
{formats0-0-And-1-0, formats0-1-And-1-1},
          ...,
        }
    }
OPTIONAL -- Cond Setup2
  }
```

According to configuration information, the base station may configure one or multiple search space sets for the terminal. According to some embodiments, the base station may configure search space set 1 and search space set 2 for the terminal. The terminal may be configured to monitor DCI format A, which is scrambled by an X-radio network temporary identifier (RNTI), in a common search space in search space set 1, and the terminal may be configured to monitor DCI format B, which is scrambled by a Y-RNTI, in a UE-specific search space in search space set 2.

According to the configuration information, one or multiple search space sets may exist in the common search space or the UE-specific search space. For example, search space set #1 and search space set #2 may be configured to be a common search space, and search space set #3 and search space set #4 may be configured to be a UE-specific search space.

In the common search space, the terminal may monitor the following combinations of DCI formats and RNTIs. The disclosure is not limited to the following examples.
DCI format 0_0/1_0 with cyclic redundancy check (CRC) scrambled by cell RNTI (C-RNTI), configured scheduling (CS-RNTI), semi-persistent channel state information RNTI (SP-CSI-RNTI), random access RNTI (RA-RNTI), temporary C-RNTI (TC-RNTI), paging RNTI (P-RNTI), and/or system information RNTI (SI-RNTI)
DCI format 2_0 with CRC scrambled by slot format indicator RNTI (SFI-RNTI)
DCI format 2_1 with CRC scrambled by interruption RNTI (INT-RNTI)
DCI format 2_2 with CRC scrambled by transmit power control (TPC) for PUSCH RNTI (TPC-PUSCH-RNTI), transmit power control for PUCCH RNTI (TPC-PUCCH-RNTI)
DCI format 2_3 with CRC scrambled by transmit power control for sounding reference signal RNTI (TPC-SRS-RNTI)

In the UE-specific search space, the terminal may monitor the following combinations of DCI formats and RNTIs. The disclosure is not limited to the following examples.
DCI format 0_0/1_0 with CRC scrambled by C-RNTI, CS-RNTI, and/or TC-RNTI
DCI format 1_0/1_1 with CRC scrambled by C-RNTI, CS-RNTI, and/or TC-RNTI RNTIs may comply with definitions and uses below.

C-RNTI: For UE-specific PDSCH or PUSCH scheduling

TC-RNTI: For UE-specific PDSCH scheduling

CS-RNTI: For semi-statically configured UE-specific PDSCH scheduling

RA-RNTI: For PDSCH scheduling during random access

P-RNTI: For scheduling of PDSCH on which paging is transmitted

SI-RNTI: For scheduling of PDSCH on which system information is transmitted

INT-RNTI: For indicating whether to puncture PDSCH

TPC-PUSCH-RNTI: For power adjustment command indication for PUSCH

TPC-PUCCH-RNTI: For power adjustment command indication for PUCCH

TPC-SRS-RNTI: For power adjustment command indication for SRS

The aforementioned DCI formats may comply with the following definitions shown below in Table 7.

TABLE 7

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

CORESET p and a search space of aggregation level L in search space set s may be expressed as the following Equation 1.

$$L \cdot \{ ( {Y}_{p , {n}_{sf}^{μ}} + ⌊ \frac{{m}_{s , {n}_{CI}} \cdot {N}_{CCE , p}}{L \cdot {M}_{p , s , max}^{( L )}} ⌋ + {n}_{CI} ) mod ⌊ {N}_{CCE , p} / L ⌋ \} + iL \cdot \{ ( {Y}_{p , {n}_{s , f}^{μ}} + ⌊ \frac{{m}_{s , {n}_{CI}} \cdot {N}_{CCE , p}}{L \cdot {M}_{p , s , max}^{( L )}} ⌋ + {n}_{CI} ) mod ⌊ {N}_{CCE , p} / L ⌋ \} + i$$

where:
L: aggregation level
n_{CI}: carrier index
N_{CCE,p}: a total number of CCEs existing in control resource set p
n_{s,f}^{μ}: slot index
M_{p,s,max}^{(L)}: the number of PDCCH candidates of aggregation level L
m_{s,n}_{_{CI}}=0, . . . , M_{p,s,max}^{(L)}−1: indexes of PDCCH candidates of aggregation level L
i=0, . . . , L−1
Y_{p,n}_{_{s,f}}_{^{μ}}=(Aₚ·Y_{p,n}_{_{s,f}}_{^{μ}}₋₁)mod D, Y_{p,-1}=n_{RNTI}≠0, A₀=39827, A₁=39829, A₂=39839, and D=65537
n_{RNTI}: terminal identity
A Y_{p,n}_{_{s,f}}_{^{μ}} value may correspond to 0 for a common search space.

For a UE-specific search space, the Y_{p,n}_{_{s,f}}_{^{μ}} value may correspond to a value that varies according to a time index and an ID (a C-RNTI or an ID configured for the terminal by the base station) of the terminal.

As a method for supporting a high-speed data service, a data rate may be increased via a spatial multiplexing method using multiple transmission/reception antennas. In general, the number of required power amplifiers increases in proportion to the number of transmission antennas provided in a base station or a terminal. A maximum output of a base station and a terminal depends on a characteristic of a power amplifier, and in general, a maximum output of a base station depends on a cell size covered by the base station. A maximum output is usually expressed in decibel milliwatts (dBm). A maximum output of a terminal is usually 23 dBm or 26 dBm. As described above, energy consumption of a base station is greatly influenced by a power amplifier operation. Since a power amplifier is involved in base station transmission, downlink transmission of the base station is highly related to energy consumption of the base station. Relatively, uplink reception of the base station does not account for a large portion of energy consumption of the base station. Physical channels and physical signals transmitted by the base station in a downlink are as follows.
PDSCH: a downlink data channel including data to be transmitted to one or multiple terminals.
PDCCH: a downlink control channel including scheduling information for PDSCH and PUSCH. Alternatively, control information, such as a slot format and a power control/adjustment command, may be transmitted on a PDCCH alone without involvement of a PDSCH or PUSCH to be scheduled. The scheduling information includes resource information to which a PDSCH or PUSCH is mapped, HARQ-related information, power control information, etc.
PBCH: a downlink broadcast channel that provides an MIB which is essential system information required for transmission and reception of a data channel and a control channel of the terminal.
PSS: a PSS is a signal that serves as a reference for DL time/frequency synchronization, and provides some information of a cell ID.
SSS: a signal serving as a reference for DL time and/or frequency (hereinafter, referred to as time/frequency) synchronization, and providing some of the remaining cell ID information.
Demodulation reference signal (DM-RS): a reference signal for channel estimation of the terminal for each PDSCH, PDCCH, and PBCH.
Channel-state information reference signal (CSI-RS): a downlink signal that serves as a reference for measuring of a downlink channel state by the terminal.
Phase-tracking reference signal (PT-RS): a downlink signal for phase tracking.

From the perspective of energy saving of the base station, when the base station stops downlink transmission, energy saving of the base station may be increased due to stopping of a power amplifier operation according to the stopping of the downlink transmission. The operations of not only the power amplifier but also a remaining base station device, such as a baseband device, are reduced, so that additional energy saving is possible. Likewise, even for uplink reception which accounts for a relatively small portion of a total energy consumption of the base station, if the uplink reception is stoppable, additional energy savings may be achieved.

Downlink transmission of the base station basically depends on the amount of downlink traffic. For example, if there is no data to be transmitted to the terminal via a downlink, the base station does not need to transmit a PDSCH and a PDCCH for scheduling of the PDSCH. Alternatively, if transmission can be suspended for a certain amount of time, such as if the transmission data is not sensitive to a transmission delay, the base station may not transmit a PDSCH and/or a PDCCH. Hereinafter, for convenience of description, such a method of reducing base station energy consumption by appropriately adjusting or not transmitting a PDSCH and/or PDCCH associated with data traffic is referred to as “base station energy saving method 1-1”.

On the other hand, physical channels and physical signals, such as PSS, SSS, PBCH, and CSI-RS, are transmitted repeatedly at a predetermined period regardless of data transmission to the terminal. Therefore, even if the terminal does not receive data, the terminal may continuously update downlink time/frequency synchronization, a downlink channel state, a radio link quality, etc. In other words, PSS, SSS, PBCH, and CSI-RS necessarily require downlink transmission regardless of downlink data traffic, and result in base station energy consumption. Accordingly, base station energy consumption may be achieved by adjusting signal transmission irrelevant (or less relevant) to data traffic to occur less frequently (hereinafter, referred to as “base station energy saving method 1-2”).

During a time interval when the base station does not perform downlink transmission via “base station energy saving method 1-1” or “base station energy saving method 1-2”, the energy saving effect of the base station may be maximized by stopping or minimizing operations of a device (e.g., a baseband device or a radio frequency (RF) device) related to the operation of the power amplifier of the base station.

Alternatively, the energy consumption of the base station may be reduced by switching off some of antennas or power amplifiers of the base station (hereinafter, “base station energy saving method 2”). In this case, as a reaction to the energy saving effect of the base station, adverse effects, such as a decrease in cell coverage or a decrease in throughput, may occur. For example, there may be a base station equipped with 64 transmitting antennas and 64 corresponding power amplifiers in a 3.5 GHz frequency band and operating at a bandwidth of 100 MHZ. For such energy saving of the base station, when only four transmission antennas and four power amplifiers are activated and the rest are switched off for a predetermined time interval, base station energy consumption during the time interval is reduced to approximately 1/16 (=4/64). When only four transmission antennas and four power amplifiers are activated and the rest are switched off for the predetermined time interval, it is difficult, due to a decrease in a maximum transmission power and a decrease in beamforming gain, to achieve cell coverage and throughput obtained when the existing 64 antennas and power amplifiers are assumed.

In the following description, in order to distinguish from a normal base station operation, a base station mode of applying an operation for base station energy saving is referred to as an energy saving (ES) mode, and a base station mode of applying a normal base station operation is referred to as a base station normal mode.

As another method to support a high-speed data service, the 5G and 6G systems may support ultra-wide bandwidth signal transmission and reception of tens to hundreds of MHz or of several GHz. Ultra-wide bandwidth signal transmission and reception may be supported via a single-component carrier (circuit) or may be supported via a CA technology of combining multiple component carriers. When a mobile communication operator fails to secure a sufficient bandwidth frequency to provide ultra-high speed data services with a single-component carrier, the carrier aggregation technology may allow combining of individual component carriers having relatively small bandwidths to increase a total frequency bandwidth, thereby consequently enabling ultra-high speed data services.

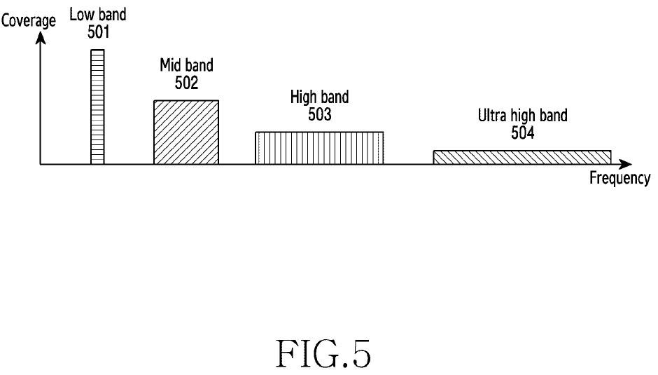

FIG. 5 illustrates a correlation between a frequency band, coverage, and a bandwidth, according to an embodiment. As described above, frequency bands used by the 5G and 6G systems are wide ranging from hundreds of MHz to tens of GHz. In general, the lower the frequency band, the larger the coverage due to relatively a low path loss, and the larger the frequency band, the smaller the coverage due to a relatively high path loss (low band 501, mid band 502, high band 503, and ultra high band 504). While frequencies available for mobile communication are relatively less and a bandwidth is small in a low frequency band, a high frequency band is suitable for a high-speed data service due to relatively easy securing of a wide bandwidth frequency. As mobile communication systems evolve, efforts are being made to discover and utilize a new frequency band. For example, in a 6G mobile communication system which is a next-generation mobile communication system, a THz band may be a candidate frequency.

Generally, a mobile communication operator secures multiple frequency bands to provide a mobile communication service to users. For example, a mobile communication operator may operate a system, in which LTE and 5G are combined, by combining previously secured frequency bands for the LTE system and newly secured frequency bands for the 5G system. Additionally or alternatively, a mobile communication operator may secure frequency bands for the 5G system across multiple bands, and then combine frequencies of the multiple bands to provide a mobile communication service via 5G CA. As described above, since characteristics, such as coverage and bandwidth, vary depending on a frequency band, a mobile communication service with combined multiple frequency bands is more frequent used compared to a mobile communication service which relies on a single-frequency band.

Hereinafter, system operations proposed in the disclosure will be described via specific embodiments. It is noted that one or more of the embodiments below may be used in combination with each other. Power saving methods for a base station and a network presented in the disclosure may be used in, for example, 5G and 6G systems.

According to an embodiment (a first embodiment) a communication system structure in which frequencies of multiple bands are combined to enhance frequency use efficiency. The frequencies may be immediately adjacent or distant in the frequency domain.

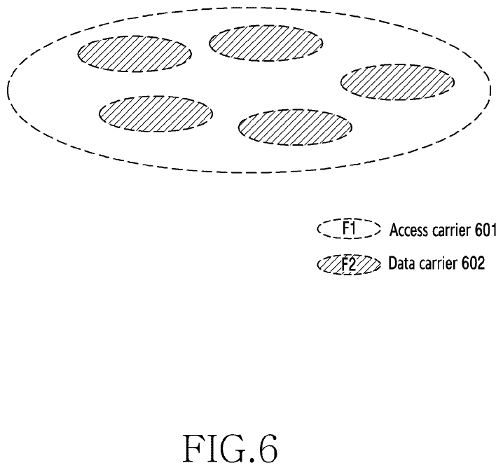

FIG. 6 illustrates an example of a communication system including an access carrier and a data carrier, according to an embodiment.

Referring to FIG. 6, the communication system may include a carrier 601 operating at frequency F1 and a carrier 602 operating at frequency F2. As an example, a case where F1<F2 may be considered. In this case, F1 is advantageous in coverage due to a relatively low frequency band, but has limitations in providing a high-speed data service due to bandwidth constraints. F2 is relatively disadvantageous in coverage due to a relatively high frequency band, but is advantageous for a high-speed data service due to a relatively wide bandwidth. The disclosure is not limited to F1 and F2 being classified as different carriers. F1 and F2 may represent different frequency domains on the same carrier. On the other hand, F1 and F2 may be used to distinguish different types of cells. Alternatively, F1 and F2 may be used to distinguish a specific signal and channel depending on transmission of the same. Therefore, it is noted that F1 and F2 may be replaced with other terms which distinguish carriers, distinguish frequency domains, distinguish cells, distinguish whether a specific signal and channel are transmitted, or describe respective purposes. As an example, F1 may be referred to as an anchor cell and F2 may be referred to as a network energy saving (NES) cell. In another example, F1 may be referred to as a cell in which SSB and system information 1 (SIB1) are transmitted, and F2 may be referred to as an SSB-less cell and an SIB-less cell. In another example, F1 may be referred to as a coverage cell, and F2 may be referred to as a capacity cell. It is noted that the terms for F1 (for convenience of description, hereinafter, referred to as “access carrier”) 601 and F2 (for convenience of description, hereinafter, referred to as “data carrier”) 602 in the disclosed are not limited to the terms presented above. The terms above are defined in based on functions in the disclosure, and may vary depending on intention or usage of users or operators. Therefore, the definitions should be made based on content throughout the specification.

Sizes of the circles illustrated in FIG. 6 indicate coverage sizes that respective carriers are able to provide. The example of FIG. 6 illustrates that multiple data carriers coexist within coverage of an “access carrier.” The access carrier and the data carriers are connected to each other through a wire or wirelessly to enable smooth cooperation. A base station and a terminal, to which the first embodiment is applied, support operations in F1 and F2. Therefore, via the first embodiment, coverage and a high-speed data service may be provided according to a situation. In the disclosure, the base station may have a combination of an access carrier and a data carrier, or an access carrier and a data carrier may be implemented as separate base stations. If an access carrier and a data carrier are implemented in a single base station, the access carrier and the data carrier may be referred to as transmission reception points (TRPs) each of which uses a different frequency. Hereinafter, operations performed by an access carrier or a data carriers may be understood as being performed by a base station providing the access carrier or a base station providing the data carriers, respectively. For example, maintaining of an access carrier in a switched on state may indicate that a base station providing the access carrier maintains the access carrier in the switched on state. In another example, maintaining a data carrier in a switched off state or switching on only a reception operation may indicate that a base station providing the data carrier maintains the data carrier in the switched off state or switches on only the reception operation of the data carrier.

The access carrier serves to provide essential information of the communication system, such as the aforementioned synchronization signal, PBCH, and system information, and may maintain a switched on state (switch on) to support all terminals within the system regardless of states of the terminals. A switched-on base station maintains a transmission block and a reception block turned on, and performs normal transmission and reception. A terminal performs initial access via the access carrier. The data carrier switches between switched on and switched off states (switch off) as required. In the switched off state, power of the base station is maintained partially or fully off. Typically, the data carrier is switched on to provide a service to a connected terminal which has completed initial access, and if there is no terminal to receive a service, the data carrier is switched to a switched off state so as to prevent unnecessary energy consumption of the base station. Unlike the access carrier, the data carrier may increase frequency efficiency by omitting or minimizing transmission of essential information provided to a terminal.

Depending on whether the terminal is in an initial access stage, the first embodiment may classify a state of the terminal in a connected state (or an RRC_CONNECTED state), an idle state (or an RRC_IDLE state), and an inactive state (or an RRC_INACTIVE state). In addition, when the terminal is turned on, the terminal performs, as preparation for data communication with the base station, a series of initial access commands, such as performing time-frequency synchronization with the base station, acquiring system information from the base station, and performing random access. The terminal, during the initial access, may be idle or inactive. When the initial access is completed, the terminal may be switched to a connected state and perform one-to-one data transmission and reception to and from the base station.

A scenario in which a terminal performs initial access with a base station will now be described (scenario 1-1).

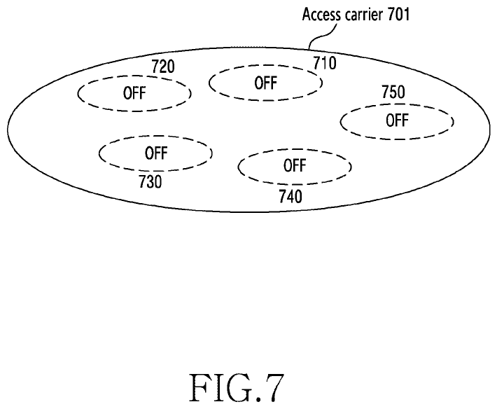

FIG. 7 illustrates an example of an operation scenario of the communication system including an access carrier and a data carrier, according to an embodiment.

Referring to FIG. 7, a system including an access carrier 701 and data carriers 710, 720, 730, 740, and 750, is shown. Provided is a case where there is no connected terminal in the current system, and as described above, the access carrier maintains a switched on state to support all terminals in the system regardless of states of the terminals. On the other hand, the data carriers maintain a switched off state, and a base station energy saving effect is thus expected. An idle terminal acquires data (e.g., a synchronization signal or system information) from the access carrier and based thereon, the terminal performs random access with the access carrier.

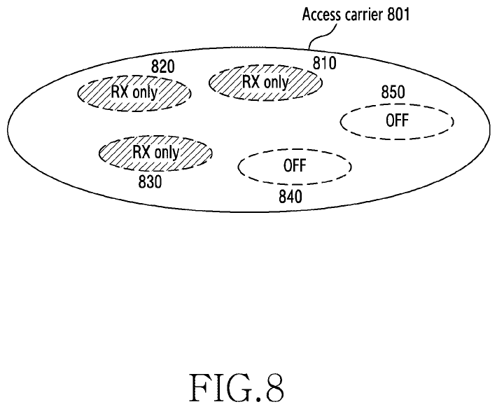

FIG. 8 illustrates an example of an operation scenario of the communication system including an access carrier and a data carrier, according to an embodiment.

A scenario in which a terminal performs initial access with a base station will now be described (scenario 1-2).

Referring to FIG. 8, a system including an access carrier 801 and data carriers 810, 820, 830, 840, and 850, is shown. Provided is a case where there is no connected terminal in the current system, and as described above, the access carrier maintains a switched on state to support all terminals in the system regardless of states of the terminals. For FIG. 8, some of the data carriers (840 and 850, hereinafter, referred to as “data carrier set #1”) are expected to maintain a switched off state for both transmission and reception, and a base station energy saving effect is thus expected. For some of the other data carriers (810, 820, and 830, hereinafter, referred to as “data carrier set #2”), transmission is switched off while reception is switched on, and a partial base station energy saving effect is thus expected. In scenario 1-2, similar to scenario 1-1, an idle terminal acquires data (e.g., a synchronization signal or system information) from the access carrier, and based thereon, the terminal performs random access. However, in scenario 1-2, unlike scenario 1-1, the terminal may perform random access with respect to the access carrier or data carrier set #2. The access carrier or data carrier set #2 may receive an uplink signal transmitted by the terminal during the random access.

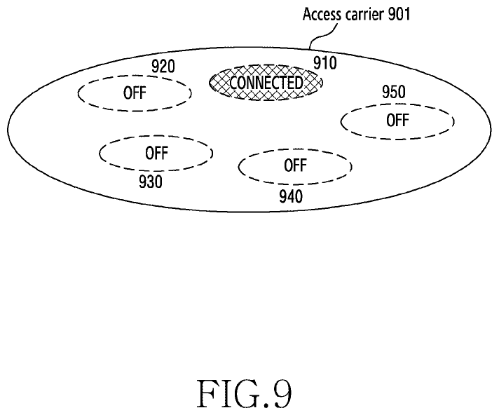

FIG. 9 illustrates an example of an operation scenario of the communication system including an access carrier and a data carrier, according to an embodiment.

A scenario in which a terminal performs data communication with a base station will now be described (scenario 2).

A terminal having completed initial access may perform one-to-one data communication with a data carrier. Referring to FIG. 9, a data carrier 910 is determined to be the most appropriate base station to provide a service to a currently connected terminal, so that the data carrier 910 is switched to a switched on state to perform one-to-one data communication with the terminal. Determination on which data carrier an access carrier 901 is to switch on or off may vary depending on a scenario in which a terminal performs initial access with a base station. If a terminal performs random access with a data carrier, when the random access of the terminal is completed, the corresponding data carrier (base station) may need to be continuously switched on in order for the data carrier and the terminal to perform one-to-one data communication. However, if the terminal performs random access with an access carrier rather than a data carrier, when the random access of the terminal is completed, the access carrier may need to determine a data carrier to be switched on, and support one-to-one data communication between the data carrier and the terminal. The disclosure proposes a power saving method via base station control (access carrier and data carrier) required in such cases. Detailed methods will be proposed via the following embodiments.

It has been assumed that the access carrier maintains the switched on state to support all terminals in the system regardless of states of the terminal, but the access carrier may also be able to perform energy saving-related operations in various ways for network power saving. Therefore, the access carrier may also be switched off at a specific point in time. For example, an operation, such as discontinuous transmission (DTX) and discontinuous reception (DRX), may be performed in the access carrier. In addition, in the following embodiments, a method of switching a data carrier on and off as needed and a method of performing power control of a switched-on data carrier are proposed, but in addition to this, energy saving-related operations may be performed in various additional ways. For example, an operation, such as DTX/DRX, may also be performed in a data carrier.

According to an embodiment (a second embodiment), for network power saving, an access carrier controls a data carrier to be switched on and off as needed, and the switched on data carrier effectively performs power control to enable a terminal to perform one-to-one data communication with the data carrier. In addition, a method of controlling a data carrier based on range, distance, and/or direction information of a terminal with respect to an access carrier (base station) is proposed.

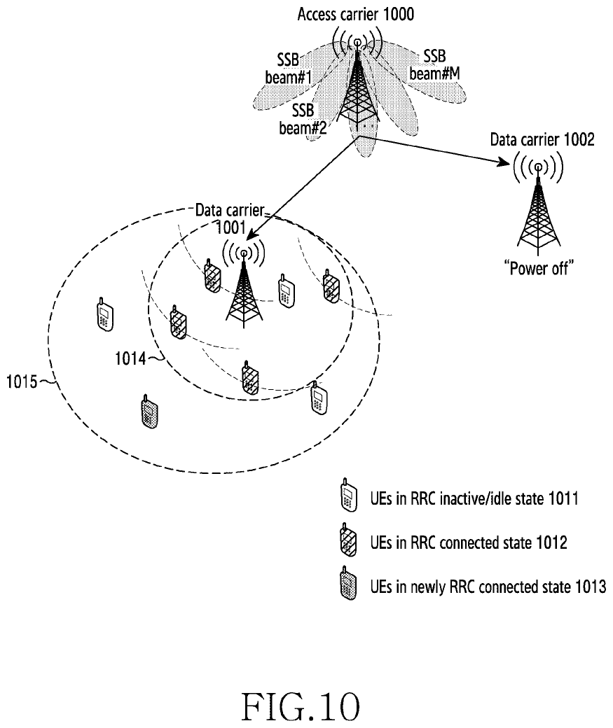

FIG. 10 illustrates an example of a scenario of controlling a data carrier based on range, distance and/or direction information of a terminal while performing initial access by the terminal via an access carrier, according to an embodiment.

Referring to FIG. 10, a terminal performs initial access via an access carrier 1000. A terminal 1011 in initial access may be idle or inactive. A terminal having completed initial access is a connected terminal 1012 and may perform one-to-one data communication with a data carrier 1001 or 1002. In addition, as time passes, the connected terminal 1012 may be switched back to the idle or inactive terminal 1011. In addition, a newly connected terminal 1013 may appear. Therefore, it is necessary to perform network power saving by applying the states of these terminals. In FIG. 10, the single access carrier 1000 and the two data carriers 1001 and 1002 are illustrated for convenience of description, but the disclosure is not limited thereto.

In FIG. 10, an example is illustrated in which no terminal is distributed around the data carrier 1002, while multiple terminals are distributed around the data carrier 1001. According to the embodiment of FIG. 10, for network power saving, a base station switches only the data carrier 1001, which is the most appropriate to provide a service to the currently connected terminal, to a switched on state to perform one-to-one data communication with the terminal, and the other data carrier 1002 remains switched off so that a base station energy saving effect is expected. In order to make this configuration, the access carrier 1000 may need to identify a position of the data carrier 1001 or 1002 and a position of the terminal 1011, 1012, or 1013. In FIG. 10, as a method of identifying a terminal position, a method based on range, distance, and/or direction information of the terminal with respect to the access carrier (base station) is considered. To this end, the access carrier 1000 may perform beamforming on SSB in various directions to perform transmission, via configuration for multiple SSB transmissions. FIG. 10 illustrates a case in which M SSB beams are formed, and SSBs are transmitted in M different directions. The following examples may be considered so that the access carrier 1000 identifies direction information (or range information) and angle information (or direction information) of terminals with respect to the terminal 1011 in initial access.

In an example (example 1-1), the terminal 1011 in initial access may transmit/report, to the access carrier 1000, N(≥1) physical random-access channels (PRACHs) for a received SSB beam.

In example 1-1, it is assumed that SSB beam reception of the terminal and PRACH transmission related thereto are associated. Therefore, the terminal may receive M SSBs, and for N(≥1) SSB beams having a good reception state among the M SSBs, perform associated N(≥1) PRACH transmissions. Then, the access carrier may, via this information, identify N(≥1) best beam directions and identify the direction and angle information of the terminal.

In an example (example 1-2), the terminal 1011 in initial access may transmit/report N(≥1) SSB reference signals received powers (RSRPs) to the access carrier 1000.

For a transmission time point of SSB RSRP information in example 1-2, the SSB RSRP information may be included in information of message 3 330 and transmitted via a PUSCH during initial access with reference to FIG. 3. Alternatively, the SSB RSRP information may be included in other message information (e.g., message 5 information) transmitted to complete the initial access, and transmitted via a PUSCH. Then, the access carrier may, via this information, identify N(≥1) best beam directions and identify the direction and angle information of the terminal. However, in the disclosure, a point in time and channel, in which SSB RSRP information is transmitted, is not limited to a specific method.

In an example (example 1-3), the connected terminal 1012 or 1013 after initial access may transmit/report N(≥1) SSB RSRPs to the access carrier 1000.

For a transmission time point of SSB RSRP information in example 1-3, the SSB RSRP information may be transmitted via a PUSCH at a specific point in time after the initial access is completed and the terminal is connected. Then, the access carrier may, via this information, identify N(≥1) best beam directions and identify the direction and angle information of the terminal. In the disclosure, a point in time and channel, in which SSB RSRP information is transmitted, is not limited to a specific method. However, compared to example 1-3, since example 1-1 and example 1-2 are methods of providing related information to the access carrier during initial connection, the access carrier may be able to more quickly identify the direction and angle information of the terminal.

In the above examples 1-1, 1-2, and 1-3, a reason that the terminal provides N(≥1) PRACHs and N(≥1) pieces of SSB RSRP information to the access carrier (base station) is that usefulness of the direction and angle information of the terminal acquired via the information provided by the terminal may vary according to a beam pattern and the number M of SSB beams configured by the access carrier. For example, when a sharp SSB beam is used, it may be safer for the terminal to report N, which indicates a plural number, to identify an angle of the terminal. In other words, in this case, if the terminal reports only N=1, there is a possibility that a direction of the terminal may be misunderstood. In addition, reporting of N indicating a plural number may be advantageous for the access carrier to identify multiple data carriers adjacent to the terminal. Since selecting a data carrier based on terminal position information with respect to the access carrier is not a method based on a link and a channel state of the data carrier and the terminal, there may be limitations in selecting an appropriate data carrier. Therefore, based on N information, the access carrier may switch on multiple data carriers. For further details, reference is made to another embodiment (embodiment 4), below. Therefore, the access carrier 1000 may indicate configuration information on an N value to the terminal. In addition, the terminal may provide the access carrier (base station) with information on N(≥1) PRACHs and N(≥1) SSB RSRPs according to the configured N value. The configuration information on the N value may be included in the system information and provided by the access carrier 1000. For example, SIB1 may include a value for N. However, in the disclosure, a method of providing configuration for an N value is not limited to a specific method.

In addition, during the initial access of the terminal 1011 to the access carrier 1000, the access carrier 1000 may identify terminal range or distance information of the terminal 1011. The access carrier 1000 may measure timing advance (TA) via a PRACH transmitted by the terminal 1011. In addition, during the measurement, a terminal distance may be identified.

Therefore, the access carrier 1000 may identify a position of the data carrier 1001 or 1002 and a position of the terminal 1011 in initial access or a position of the terminal 1012 or 1013 having completed the initial access, so as to select an appropriate data carrier to enable the terminal to perform one-to-one data communication with the data carrier. In this case, K(≥1) data carriers close to the position of the terminal may be selected. One or more data carriers are selected because data carrier selection based on the position of the terminal is not selection according to an actual link and a channel state between the data carrier and the terminal. According to an embodiment, detailed operations after selecting K(≥1) data carriers will be described (embodiment 4).

Referring to FIG. 10, a case is illustrated, in which, for network power saving, the data carrier 1001 is selected and switched on, while the data carrier 1002 is switched off. In addition, a case is illustrated, in which, when the data carrier 1001 is selected and switched on, appropriate power control is performed and coverage is adjusted as in reference numeral 1014 so that the terminal supports data communication with the data carrier 1001. However, a case is illustrated, in which, as time passes, the new terminal 1013 switched to a connected state appears, so that coverage is adjusted as in reference numeral 1015 via power control so as to support the terminal 1013. Such a method of enabling power control will be described in more detail via the following embodiment.

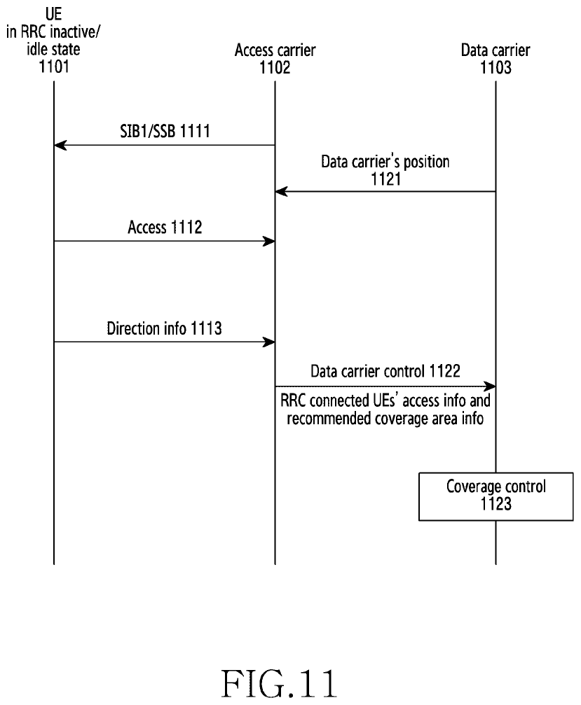

FIG. 11 illustrates an example of a procedure in which an access carrier controls a data carrier, based on distance and direction information of a terminal, according to an embodiment.

Referring to FIG. 11, a base station power saving procedure according to the second embodiment will be described in detail. First, an access carrier 1102 (or base station which controls (or provides information to) the access carrier 1102) provides the aforementioned essential information of the communication system, such as a synchronization signal, a PBCH, and system information, and causes all the terminals in the system to perform initial access via the access carrier 1102 regardless of states of the terminals. Accordingly, the access carrier 1102 may provide, in operation 1111, SIB1 for idle or inactive UEs (terminals) 1101 which are to perform initial access and may transmit a synchronization signal and a PBCH via SSB. The idle or inactive terminals 1101 may identify the system information by using the information received in operation 1111 and perform synchronization with the access carrier 1102. In addition, the terminals 1101 may perform initial access to the access carrier 1102 in operation 1112. For details on this, reference is made to FIG. 3. It has been previously described that, in operation 1112, the access carrier 1102 may identify range or distance information of the terminals 1101.

According to the examples described above, in order for the access carrier 1102 to identify direction and angle information of the terminals 1101, the terminals may transmit/report information that enables the access carrier 1102 to identify directions of the terminal 1101 in operation 1112 or 1113. For details on this, reference is made to example 1-1 to example 1-3.

In addition, in operation 1121, a data carrier 1103 (or base station which controls (or provides information to) the data carrier 1103) may provide the access carrier 1102 with coordinate position information of the data carrier (or base station which controls (or provides information to) the data carrier). According to the above procedure, the access carrier 1102 may identify the position of the data carrier 1113 and the positions of the idle or inactive terminals 1101, and may control the data carrier 1103, in operation 1122, based on the identified positions. The controlling of the data carrier 1113 by the access carrier 1102 in operation 1122 may include switching the data carrier between a switched on state and a switched off state as needed. In addition, providing related information to enable the switched-on data carrier to perform power control in operation 1123 may also be included. To this end, coverage information of the data carrier may be indicated in operation 1122. According to an embodiment, the coverage information of the data carrier may be acquired from terminal position information (embodiment 5).

In operation 1122, the access carrier 1102 may switch on the data carrier 1113 and provide terminal information identified after completion of the initial access in operation 1112, that is, access information of the connected terminal. The information may include UE ID information. In addition, the information may include terminal access state information. This may be information on a terminal newly switched to an idle or inactive state and information on a terminal newly switched to a connected state. Via the information, the data carrier 1113 may dynamically perform power control in operation 1123 and perform one-to-one data communication with the connected terminal. Here, dynamically performing the power control may indicate that the power control is performed in a short time unit, and the time unit may include power control performed at a slot level or symbol level.

According to an embodiment (a third embodiment), for network power saving, an access carrier controls a data carrier to be switched on and off as needed, and the switched on data carrier effectively performs power control to enable a terminal to perform one-to-one data communication with the data carrier. A method of controlling a data carrier based on coordinate position information of a terminal with respect to an access carrier (base station) is proposed.

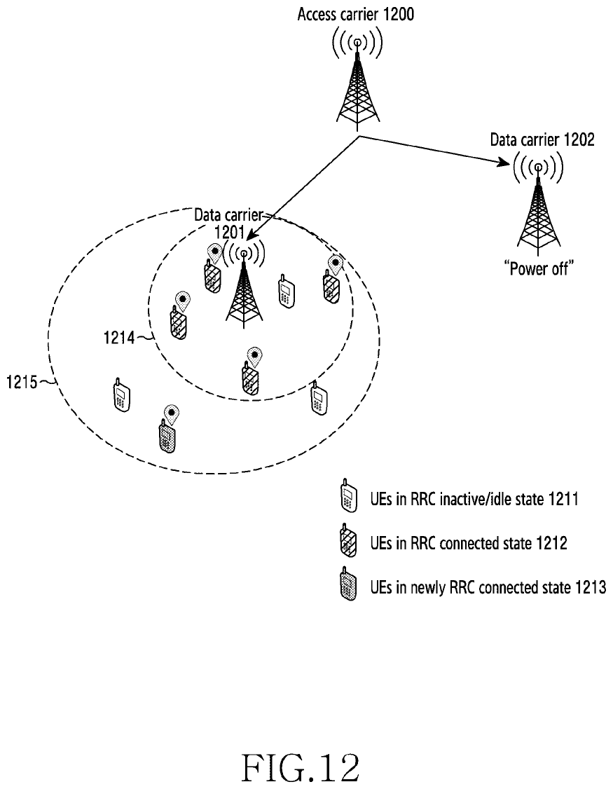

FIG. 12 illustrates an example of a scenario to describe a method of controlling a data carrier based on coordinate position information of a terminal with respect to an access carrier while performing initial access by the terminal via the access carrier, according to an embodiment.

Referring to FIG. 12, a terminal performs initial access via an access carrier 1200. A terminal 1211 in initial access may be idle or inactive. A terminal having completed initial access is a connected terminal 1212 and may perform one-to-one data communication with a data carrier 1201 or 1202. In addition, as time passes, the connected terminal 1212 may be switched back to the idle or inactive terminal 1211. In addition, a newly connected terminal 1213 may appear. Therefore, a base station needs to perform network power saving by applying the states of these terminals. In FIG. 12, the single access carrier 1200 and the two data carriers 1201 and 1202 are illustrated for convenience of description, but it is noted that the disclosure is not limited thereto.

Referring to FIG. 12, an example is illustrated, in which no terminal is distributed around the data carrier 1202, while multiple terminals are distributed around the data carrier 1201. For network power saving, the base station switches only the data carrier 1201, which is the most appropriate to provide a service to the currently connected terminal, to a switched on state to perform one-to-one data communication with the terminal, and the other data carrier 1202 remains switched off so that a base station energy saving effect is expected. In order to make this possible, the access carrier 1200 may need to identify a position of the data carrier 1201 or 1202 and a position of the terminal 1211, 1212, or 1213. In FIG. 12, as a method of identifying a position of a terminal, a method based on coordinate (e.g., an (x,y) coordinate or an (x,y,z) coordinate) information of the terminal with respect to an access carrier (or base station which controls or provides information to the access carrier) is considered. The following examples may be considered so that the access carrier 1200 identifies coordinate information of terminals with respect to the terminal 1211 in initial access.

In an example (example 2-1), a radio access technology (RAT)-independent-based positioning method is used so that a terminal may transmit/report coordinate information to the access carrier 1200.

In example 2-1, as an example of the RAT-independent-based positioning method, global positioning system (GPS) information may be used. However, RAT-independent-based positioning may include all positioning methods other than positioning (e.g., RAT dependent positioning) via transmission and reception of a positioning signal between a base station and a terminal. A terminal may acquire coordinate information of the terminal via a GPS. However, a method that uses a GPS has a disadvantage of a terminal being unable to use the method in a shaded area where a GPS signal does not reach.

In an example (example 2-2), an RAT-dependent-based positioning method is used so that a terminal may transmit/report coordinate information to the access carrier 1200.

In example 2-2, the RAT-dependent-based positioning method refers to a positioning method via transmission and reception of a positioning signal between a base station and a terminal. In particular, in a UE-based positioning method, a terminal may directly calculate coordinate information of the terminal, based on a positioning signal transmitted by the access carrier (base station).

In an example (example 2-3), the RAT-dependent-based positioning method is used so that a location server may transmit/report terminal coordinate information to the access carrier 1200.

In example 2-3, the RAT-dependent-based positioning method refers to a positioning method via transmission and reception of a positioning signal between a base station and a terminal. However, this is a method of providing terminal coordinate information by the local server instead of the terminal. A method of identifying terminal coordinate information by the local server may include using positioning measurement information measured from a positioning signal received by a terminal from the access carrier (base station) or using positioning measurement information measured from a positioning signal received by the access carrier from a terminal.

When the RAT-dependent-based positioning method (example 2-2 or example 2-3) is used among the presented examples, the method may also be used in areas (e.g., tunnels and underground parking lots) where a GPS signal does not reach, based on an assumption that coverage of the access carrier (base station) covers all areas. In addition, when the RAT-dependent-based positioning method is used, even the idle or inactive terminal 1211 may be able measure a positioning signal received from the access carrier (base station). A positioning signal transmitted by the access carrier (base station) to a terminal may be referred to as a downlink positioning reference signal (DL PRS). When the idle or inactive terminal 1211 receives a DL PRS and performs a measurement, a positioning measurement result of the terminal and coordinate position information directly calculated by the terminal may be transmitted/reported to the access carrier 1200 after the terminal is connected (RRC connected). In the existing RAT-dependent positioning method, transmitting/reporting, to the access carrier (base station), a positioning measurement result of a terminal and coordinate position information directly calculated by the terminal is not supported. In the existing RAT-dependent positioning, a positioning measurement result of a terminal and coordinate position information directly calculated by the terminal are transferred to a location server instead of a base station. Here, the location server may refer to a location management function (LMF).

According to the presented examples, the access carrier 1200 may identify the position of the data carrier 1201 or 1202 and the position of the terminal 1211 in initial access or a position of the terminal 1212 or 1213 having completed the initial access, so as to select an appropriate data carrier to enable the terminal to perform one-to-one data communication with the data carrier. In this case, K(≥1) data carriers close to the position of the terminal may be selected. One or more data carriers are selected because data carrier selection based on the position of the terminal is not selection according to an actual link and a channel state between the data carrier and the terminal. For detailed operations after selecting K(≥1) data carriers, reference is made to another embodiment (embodiment 4).

Referring to FIG. 12, a case is illustrated, in which, for network power saving, the data carrier 1201 is selected and switched on, while the data carrier 1202 is switched off. In addition, a case is illustrated, in which, when the data carrier 1201 is selected and switched on, appropriate power control is performed and coverage is adjusted as in reference numeral 1214 so that the terminal supports data communication with the data carrier 1201. However, a case is illustrated, in which, as time passes, the new terminal 1213 switched to a connected state appears, so that coverage is adjusted as in reference numeral 1215 via power control so as to support the terminal 1213. Such a method of enabling power control will be described in more detail via the following embodiment.

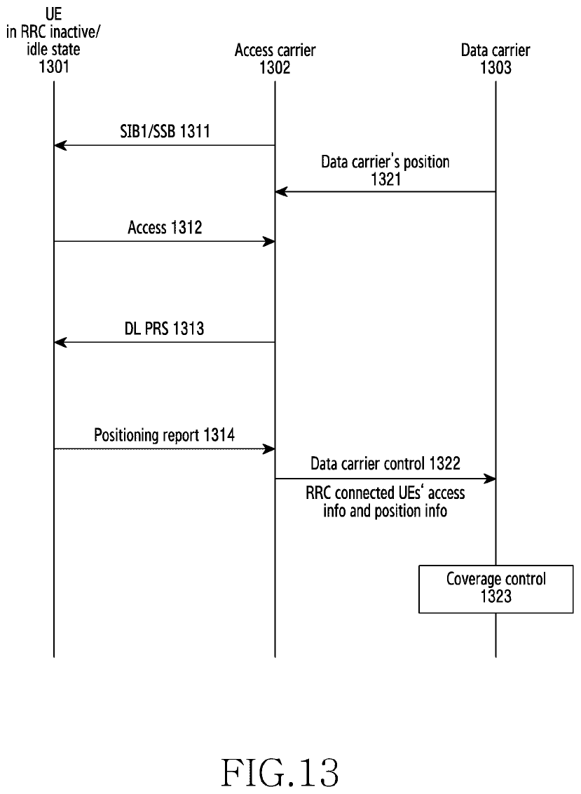

FIG. 13 illustrates an example of a procedure in which an access carrier controls a data carrier, based on coordinate position information of a terminal, according to an embodiment.

Referring to FIG. 13, a base station power saving procedure according to the third embodiment will be described in detail. First, an access carrier 1302 (or base station which controls or provides the access carrier 1302) provides the aforementioned essential information of the communication system, such as a synchronization signal, a PBCH, and system information, and causes all the terminals in the system to perform initial access via the access carrier 1302 regardless of states of the terminals. Accordingly, the access carrier 1302 may provide, in operation 1311, SIB1 for idle or inactive terminals 1301 which are to perform initial access and may transmit a synchronization signal and a PBCH via SSB. The idle or inactive UEs (terminals) 1301 may identify the system information by using the information received in operation 1311 and perform synchronization with the access carrier 1302. In addition, the terminals 1301 may perform initial access in operation 1312. For details on this, reference is made to FIG. 3.

Next, the access carrier 1302 may transmit a DL PRS to the terminals in operation 1313. However, it is noted that transmission of the DL PRS may be performed at a point in time and an operation other than operation 1313. The terminals may transmit/report, in operation 1314, positioning measurement results and coordinate position information directly calculated by the terminals to the access carrier (base station) via the DL PRS reception. In this case, the information may be transmitted via a PUSCH. However, in the disclosure, a point in time and channel, in which the information is transmitted in operation 1314, is not limited to a specific method. The information transmission in operation 1314 may be performed in another operation and at another time point.

In addition, in operation 1321, a data carrier 1303 (or base station which controls or provides information to the data carrier 1303) may provide the access carrier 1302 with coordinate position information of the data carrier (or base station which controls or provides information to the data carrier). According to the above procedure, the access carrier 1302 may identify the position of the data carrier 1313 and the position of the terminal 1311, 1312, or 1313, and may control the data carrier 1303, in operation 1322, based on the identified positions. The controlling of the data carrier 1313 by the access carrier 1302 in operation 1322 may include switching the data carrier between a switched on state and a switched off state as needed. In addition, providing related information to enable the switched-on data carrier to perform power control in operation 1323 is also included. To this end, coordinate position information of the terminal may be indicated in operation 1322. Instead of the coordinate position information of the terminal, coverage information of the data carrier may be indicated in operation 1322. According to an embodiment (embodiment 5), the coverage information of the data carrier may be acquired from position information of the terminal.

In operation 1322, the access carrier 1302 may switch on the data carrier 1313 and provide terminal information identified after completion of the initial access in operation 1312, that is, access information of the connected terminal. The information may include UE ID information. In addition, the information may include terminal access state information. This may be information on a terminal newly switched to an idle or inactive state and information on a terminal newly switched to a connected state. Via the information, the data carrier 1313 may be able to dynamically perform power control in operation 1323 and perform one-to-one data communication with the connected terminal. Here, dynamically performing the power control may indicate the power control being performed in a short time unit, and the time unit may include power control being performed at a slot level or symbol level.

According to an embodiment (embodiment 4), for network power saving, an access carrier controls a data carrier to be switched on and off as needed, and the switched on data carrier effectively performs power control to enable a terminal to perform one-to-one data communication with the data carrier. According to the method presented in embodiment 2 or embodiment 3, a data carrier to perform one-to-one data communication with a terminal is selected based on position information of the terminal with respect to an access carrier (or base station). However, such a method may have limitations because the method is not data carrier selection based on a link and a channel state between a data carrier and a terminal. Therefore, a method capable of solving such limitations of the embodiment is presented.

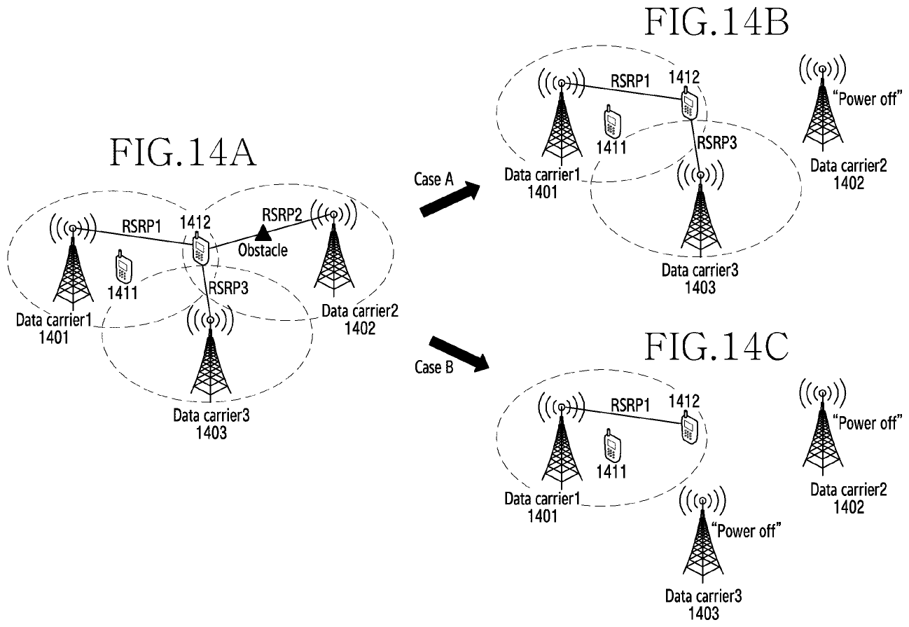

FIGS. 14A-14C illustrate an example of a procedure in which a data carrier to perform one-to-one data communication with a terminal is selected based on position information of the terminal with respect to an access carrier, according to an embodiment.

Referring to 14A, it is assumed that data carrier 1 1401 (or base station which controls or provides information to data carrier 1 1401) is already switched on to support another terminal 1411. In addition, it is assumed that data carrier 2 1402 (or base station which controls or provides information to data carrier 2 1402) and data carrier 3 1403 (or base station which controls or provides information to data carrier 3 1403) are switched on to support a terminal 1412. Data carrier 2 1402 and data carrier 3 1403 are assumed to be appropriate data carriers to perform one-to-one data communication with the terminal 1412, based on position information of the terminal 1412. For example, a data carrier located close to the terminal 1412 may be selected.

Next, a CSI-RS may be transmitted on a switched-on data carrier. A CSI-RS is a signal transmitted to identify a channel state between a data carrier and a terminal. However, a signal of a different name to identify a channel state between a data carrier and a terminal may also be used, in which case, the term CSI-RS may be replaced with another term.

Referring to FIG. 14A, the terminal 1412 may measure reference signal received powers (CSI-RSRPs), based on CSI-RSs transmitted from data carrier 1 1401, data carrier 2 1402, and data carrier 3 1403. The CSI-RSRPs measured from data carrier 1 1401, data carrier 2 1402, and data carrier 3 1403 are illustrated as RSRP1, RSRP2, and RSRP3, respectively. The terminal 1412 may transmit/report the measured CSI-RSRP values to the access carrier. Via the CSI-RSRP values transferred from the switched-on data carriers, the access carrier may control the data carriers for network power saving. For example, it may be determined that the control is arbitrarily determined by the access carrier. Alternatively, a method may be considered, in which an RSRP threshold is configured and the control is performed only when CSI-RSRP<threshold. For example, when CSI-RSRP<threshold, the access carrier may determine that a corresponding data carrier is not suitable for supporting the terminal. Alternatively, when CSI-RSRP≥threshold, the access carrier may determine that a corresponding data carrier is suitable for supporting the terminal. A method in which a value for the RSRP threshold can be configured or fixed to a specific value may be considered. However, in the disclosure, it is noted that a method of configuring an RSRP threshold is not limited to a specific method.

Referring to FIG. 14A, there may be a case where RSRP2<threshold due to an obstacle. However, RSRP3 may be a case where RSRP3≥threshold. In this case, as illustrated in FIG. 14B (case A), the access carrier may control the data carriers so that data carrier 2 1402 remains switched off, and data carrier 3 1403 remains switched on. If RSRP1≥threshold, as illustrated in FIG. 14C (case B), it may be possible for the access carrier to switch on only data carrier a 1401 and to switch off both data carrier 2 1402 and data carrier 3 1403. Compared to case A, case B may be more effective in network power saving.

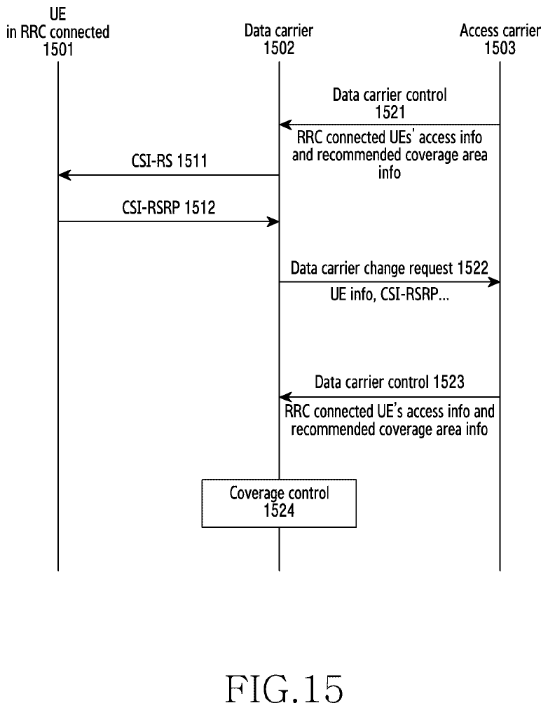

FIG. 15 illustrates an example of reselecting a data carrier based on a channel quality state of a terminal and a data carrier, according to an embodiment.

Referring to FIG. 15, a base station power saving procedure according to the fourth embodiment will be described in detail. According to a method presented in the disclosure, an access carrier 1503 (or base station which controls or provides information to the access carrier 1503) may identify a position of a data carrier 1502 and a position of a terminal, and control the data carrier 1502, in operation 1521, based on the identified positions. The controlling of the data carrier 1502 by the access carrier 1503 in operation 1521 may include switching the data carrier between a switched on state and a switched off state as needed. In addition, providing related information to enable the switched-on data carrier to perform power control in operation 1524 is also included. To this end, coverage information of the data carrier may be indicated in operation 1521. According to an embodiment (embodiment 5), the coverage information of the data carrier may be acquired from position information of the terminal.

In operation 1521, the access carrier 1503 may switch on the data carrier 1502 and provide terminal information identified after completion of the initial access, that is, access information of the connected terminal. The information may include UE ID information. In addition, the information may include terminal access state information. This may be information on a terminal newly switched to an idle or inactive state and information on a terminal newly switched to a connected state. Via the information, the data carrier 1502 may dynamically perform power control in operation 1524 and perform one-to-one data communication with the connected terminal. Here, dynamically performing the power control may indicate the power control being performed in a short time unit, and the time unit may include power control being performed at a slot level or symbol level. In addition, the connected UE (terminal) 1501 may perform one-to-one data communication with the data carrier 1502. In this case, a signal transmitted from the data carrier may include a CSI-RS, a PDSCH, a PDSCH DMRS, etc. The data carrier 1502 may transmit a CSI-RS 1511 to the terminal 1501 to identify a channel state, and the terminal 1501 may transmit/report information 1512, such as CSI-RSRP, to the data carrier 1502. When transmitting the CSI-RS 1511 to the terminal 1501, the data carrier 1502 may also indicate power information of the CSI-RS to the terminal. This may be expressed in dBm. For the data carrier 1502, since no SSB is transmitted, the power information of the CSI-RS may be a reference signal for signals transmitted from the data carrier 1502. According to an embodiment (embodiment 5), the power information of the CSI-RS may be replaced with another term.

In addition, a method may be considered, in which, in order to dynamically perform, in operation 1524, power control of the signal transmitted from the data carrier, power information of the signal transmitted from the data carrier, which includes the power information of the CSI-RS, is provided via DCI or MAC-CE. However, in the disclosure, a method of transmitting power information of a CSI-RS is not limited thereto. The power information of the CSI-RS may be indicated via RRC, and a method of indication via a combination of RRC, DCI, and MAC-CE may be considered. In addition, other signals transmitted from the data carrier may be determined based on the power information of the CSI-RS. For example, a transmission power of a PDSCH may also be determined based on the power of the CSI-RS. Specifically, a value expressed in dB, which is a ratio of a PDSCH energy per resource element (EPRE) and a CSI-RS EPRE, may be indicated.

The data carrier 1502 may identify a link and a channel state between the data carrier 1502 and the terminal 1501, based on CSI-RSRP information reported by the terminal, and may determine whether the data carrier is a suitable data carrier to provide a service to the terminal. If determined not to be suitable, the data carrier 1502 may request, in operation 1522, a change of the data carrier from the access carrier 1503. It may be determined that the request is arbitrarily determined by the data carrier. Alternatively, a method may be considered, in which an RSRP threshold is configured and the request is made only when CSI-RSRP<threshold. In this case, the access carrier 1503 may provide a value for the RSRP threshold to the data carrier 1502. However, in the disclosure, a method of configuring an RSRP threshold is not limited to a specific method. When the change of the data carrier is requested in operation 1522, a UE ID and CSI-RSRP information of the terminal may be provided together. In operation 1522, the data carrier 1502 may simply indicate data (e.g., the UE ID or the CSI-RSRP) without requesting the change of the data carrier from the access carrier 1503. In this case, the access carrier may determine whether the data carrier needs to be changed. After operation 1522, when the change or control of the data carrier is necessary, the access carrier 1503 may indicate, in operation 1523, an operation similar to operation 1521 and corresponding information to the data carrier. Then, in operation 1524, the data carrier may either switch off power or dynamically control power when switched on.

According to an embodiment (embodiment 5), a case where, for network power saving, an access carrier provides a data carrier with coverage information of the data carrier is provided. The coverage information may be calculated based on position information of a terminal acquired from the access carrier, and the data carrier may dynamically perform power control based on the information, and perform one-to-one data communication with the connected terminal. Here, dynamically performing the power control may indicate the power control being performed in a short time unit, and the time unit may include power control being performed at a slot level or symbol level. The coverage information provided by the access carrier to the data carrier may be, for example, information 1 to information 4, described below.

Information 1 is position information of the terminal. Information 1 may be range/distance and direction information of the terminal. Alternatively, information 1 may be coordinate information of the terminal. The data carrier may determine a transmission power on its own via corresponding information. The transmission power of the data carrier may be power of a signal transmitted from the data carrier, such as a transmission power of CSI-RS, a transmission power of PDSCH, and a transmission power of PDSCH DMRS. The data carrier may determine a CSI-RS power and indicate the same to the terminal. The CSI-RS power may be expressed in dBm. Based on this, a transmission power of PDSCH may also be determined. Specifically, a value expressed in dB, which is a ratio of a PDSCH EPRE and a CSI-RS EPRE, may be indicated.

Information 2 is SSB power offset information. Information 2 is based on the access carrier transmitting an SSB and the data carrier does not transmitting an SSB. The embodiment based on information 2 may be a method in which, when information 2 (SSB power offset information) is transferred from a carrier or cell (e.g., an access carrier) in which an SSB is transmitted, to a carrier or cell (e.g., a data carrier) in which no SSB is transmitted, the carrier or cell (e.g., the data carrier) in which no SSB is transmitted indicates a transmission power of its own signal to the terminal, based on the received information 2. In the embodiment based on information 2, the carrier or cell (e.g., the data carrier) in which no SSB is transmitted may determine the transmission power by directly applying information 2 received from the carrier or cell (e.g., the access carrier) in which the SSB is transmitted, but may determine a separate transmission power by referring to the received information 2. Based on the transmission power of the SSB transmitted from the access carrier, SSB power offset information may be indicated to the data carrier, and this may be used as a parameter to determine the transmission power of the CSI-RS transmitted from the data carrier. This may be expressed in dBm. The data carrier may determine the CSI-RS transmission power in accordance with the indicated SSB power offset information as it is, and may indicate the SSB power offset information to the terminal. Based on this, a transmission power of PDSCH may also be determined. Specifically, a value expressed in dB, which is a ratio of a PDSCH EPRE and a CSI-RS EPRE, may be indicated. Alternatively, the data carrier may only refer to the SSB power offset information indicated by the access carrier, and the data carrier may determine a transmission power on its own via corresponding information.

Information 3 is CSI-RS power information. Information 3 may be used to provide a method of indicating, by the access carrier, CSI-RS power information transmitted from the data carrier. The CSI-RS power information may be expressed in dBm. The embodiment based on information 3 may also be a method in which, when information 3 (CSI-RS power information) is transferred from a carrier or cell (e.g., an access carrier) in which an SSB is transmitted, to a carrier or cell (e.g., a data carrier) in which no SSB is transmitted, the carrier or cell (e.g., the data carrier) in which no SSB is transmitted indicates a transmission power of its own signal to the terminal, based on the received information 3. In the embodiment based on information 3, the carrier or cell (e.g., the data carrier) in which no SSB is transmitted may determine the transmission power by directly applying information 3 received from the carrier or cell (e.g., the access carrier) in which the SSB is transmitted, but may determine a separate transmission power by referring to the received information 3. The data carrier may determine the CSI-RS transmission power in accordance with the indicated CSI-RS power information as it is, and may indicate the CSI-RS power information to the terminal. Based on this, a transmission power of PDSCH may also be determined. Specifically, a value expressed in dB, which is a ratio of a PDSCH EPRE and a CSI-RS EPRE, may be indicated. Alternatively, the data carrier may only refer to the CSI-RS power information indicated by the access carrier, and the data carrier may determine a transmission power on its own via corresponding information.

Information 4 is coverage power information. Information 4 may be used to provide a method of indicating, by the access carrier, coverage power information of the data carrier. The coverage power information may be expressed in dBm. The embodiment based on information 4 may also be a method in which, when information 4 (coverage power information) is transferred from a carrier or cell (e.g., an access carrier) in which an SSB is transmitted, to a carrier or cell (e.g., a data carrier) in which no SSB is transmitted, the carrier or cell (e.g., the data carrier) in which no SSB is transmitted indicates a transmission power of its own signal to the terminal, based on the received information 4. In the embodiment based on information 4, the carrier or cell (e.g., the data carrier) in which no SSB is transmitted may determine the transmission power by directly applying information 4 received from the carrier or cell (e.g., the access carrier) in which the SSB is transmitted, but may determine a separate transmission power by referring to the received information 4. The data carrier may determine the CSI-RS transmission power in accordance with the indicated coverage power information as it is, and may indicate corresponding power information to the terminal. In addition, based on the CSI-RS transmission power, a transmission power of PDSCH may also be determined. Specifically, a value expressed in dB, which is a ratio of a PDSCH EPRE and a CSI-RS EPRE, may be indicated. Alternatively, the data carrier may only refer to the coverage power information indicated by the access carrier, and the data carrier may determine a transmission power on its own via corresponding information.

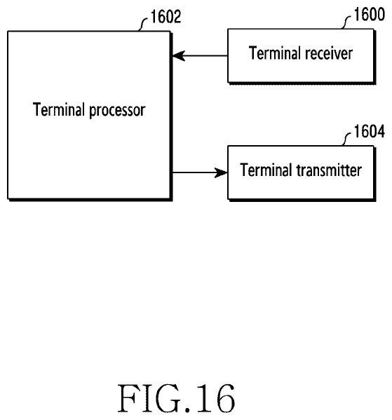

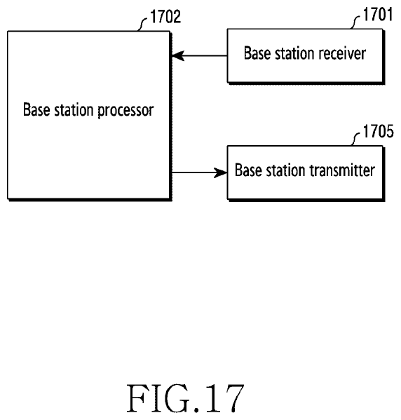

In order to perform the aforementioned embodiments of the disclosure, transmitters, receivers, and processors of a terminal and a base station are illustrated in FIG. 16 and FIG. 17, respectively. In the above embodiments, a method for power saving via a base station control is shown, and in order to perform the method, each of receivers, processors, and transmitters of a base station and a terminal needs to operate according to the embodiments. FIG. 16 is a block diagram illustrating a terminal, according to an embodiment.

Referring to FIG. 16, the terminal includes a terminal receiver 1600, a terminal transmitter 1604, and a terminal processor 1602. The terminal receiver 1600 and the terminal transmitter 1604 may collectively be referred to as transceiver in the embodiments of the disclosure. The transceiver may transmit a signal to or receive a signal from a base station. The signal may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. In addition, the transceiver may receive a signal via a radio channel and output the signal to the terminal processor 1602, and may transmit, via a radio channel, a signal output from the terminal processor 1602. The terminal processor 1602 may control a series of procedures to enable the terminal to operate according to the aforementioned embodiments of the disclosure, and the terminal processor 1602 may include a controller or at least one processor.

However, the elements of the terminal are not limited to the aforementioned examples. For example, the terminal may include more elements or fewer elements than the aforementioned elements. In addition, the terminal receiver 1600, the terminal transmitter 1604, and the terminal processor 1602 may be implemented in the form of a single chip.

FIG. 17 is a block diagram illustrating a base station, according to an embodiment. The base station in FIG. 17 may be a base station that controls or provides an access carrier, a base station that controls or provides a data carrier, or a base station that controls or provides both an access carrier and a data carrier, which are described above.

Referring to FIG. 17, the base station includes a base station receiver 1701, a base station transmitter 1705, and a base station processor 1702. The base station receiver 1701 and the base station transmitter 1705 may collectively be referred to as transceiver. The transceiver may transmit a signal to or receive a signal from a terminal. The signal may include control information and data. To this end, the transceiver may include an RF transmitter configured to perform amplification and up-conversion of a frequency of a transmitted signal, an RF receiver configured to perform low-noise amplification of a received signal and down-conversion of a frequency, etc. In addition, the transceiver may receive a signal via a radio channel, may output the signal to the base station processor 1702, and may transmit, via a radio channel, the signal output from the base station processor 1702. The base station processor 1702 may control a series of procedures to enable the base station to operate according to the aforementioned embodiments of the disclosure, and the base station processor 1702 may include a controller or at least one processor.

However, the elements of the base station are not limited to the above examples. For example, the base station may include more elements or fewer elements than the aforementioned elements. In addition, the base station receiver 1600, the base station transmitter 1604, and the base station processor 1602 may be implemented in the form of a single chip.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure.

While the present disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. A method performed by a first base station supporting an anchor carrier in a wireless communication system, the method comprising:
obtaining location related information for a terminal;
identifying whether to switch on or switch off a data carrier for network energy saving based on the location related information; and
transmitting, to a second base station supporting the data carrier, a message including identification information for the terminal and coverage information for the data carrier, based on the identification.

2. The method of claim 1, wherein the second base station does not transmit a synchronization signal and physical broadcast channel block (SSB) on the data carrier, and
wherein the coverage information includes power offset information for determining a power for a downlink transmission on the data carrier, the downlink transmission including at least one of a channel state information reference signal (CSI-RS) or a physical downlink shared channel (PDSCH).

3. The method of claim 1, wherein the location related information includes distance information and direction information for the access carrier, and
wherein the location related information is obtained from physical random access channel (PRACH) transmissions received from the terminal, synchronization signal and physical broadcast channel block (SSB) reference signal received power (RSRP) reports received from the terminal during an initial access, or SSB reports received from the terminal in a radio resource control (RRC) connected state.

4. The method of claim 1, wherein the location related information includes position information for the access carrier, and
wherein the position information includes global positioning system (GPS) information, positioning reference signal (PRS) based coordination information received from the terminal, or PRS based coordination information received from a location management function (LMF) entity.

5. The method of claim 1, further comprising:
receiving, from the second base station supporting the data carrier, a request for a data carrier change; and
transmitting, to the second base station supporting the data carrier, a response for the data carrier change.

6. A method performed by a second base station supporting a data carrier in a wireless communication system, the method comprising:
receiving, from a first base station supporting an anchor carrier, a message including identification information for a terminal and coverage information for the data carrier, wherein the message is based on location related information for the terminal; and
identifying whether to switch on or switch off the data carrier for network energy saving based on the message.

7. The method of claim 6, wherein the second base station does not transmit a synchronization signal and physical broadcast channel block (SSB) on the data carrier, and
wherein the coverage information includes power offset information for determining a power for a downlink transmission on the data carrier, the downlink transmission including at least one of a channel state information reference signal (CSI-RS) or a physical downlink shared channel (PDSCH).

8. The method of claim 6, wherein the location related information includes distance information and direction information for the access carrier, and
wherein the location related information is based on physical random access channel (PRACH) transmissions from the terminal, synchronization signal and physical broadcast channel block (SSB) reference signal received power (RSRP) reports from the terminal during an initial access, or SSB reports from the terminal in a radio resource control (RRC) connected state.

9. The method of claim 6, wherein the location related information includes position information for the access carrier, and
wherein the position information includes global positioning system (GPS) information, positioning reference signal (PRS) based coordination information from the terminal, or PRS based coordination information from a location management function (LMF) entity.

10. The method of claim 6, further comprising:
transmitting, to the first base station supporting the anchor carrier, a request for a data carrier change; and
receiving, from the first base station supporting the anchor carrier, a response for the data carrier change.

11. A first base station supporting an anchor carrier in a wireless communication system, the first base station comprising:
a transceiver; and
a controller coupled with the transceiver and configured to:
obtain location related information for a terminal,
identify whether to switch on or switch off a data carrier for network energy saving based on the location related information, and
transmit, to a second base station supporting the data carrier, a message including identification information for the terminal and coverage information for the data carrier, based on the identification.

12. The first base station of claim 11, wherein the second base station does not transmit a synchronization signal and physical broadcast channel block (SSB) on the data carrier, and
wherein the coverage information includes power offset information for determining a power for a downlink transmission on the data carrier, the downlink transmission including at least one of a channel state information reference signal (CSI-RS) or a physical downlink shared channel (PDSCH).

13. The first base station of claim 11, wherein the location related information includes distance information and direction information for the access carrier, and
wherein the location related information is obtained from physical random access channel (PRACH) transmissions received from the terminal, synchronization signal and physical broadcast channel block (SSB) reference signal received power (RSRP) reports received from the terminal during an initial access, or SSB reports received from the terminal in a radio resource control (RRC) connected state.

14. The first base station of claim 11, wherein the location related information includes position information for the access carrier, and
wherein the position information includes global positioning system (GPS) information, positioning reference signal (PRS) based coordination information received from the terminal, or PRS based coordination information received from a location management function (LMF) entity.

15. The first base station of claim 11, wherein the controller is further configured to:
receive, from the second base station supporting the data carrier, a request for a data carrier change, and
transmit, to the second base station supporting the data carrier, a response for the data carrier change.

16. A second base station supporting a data carrier in a wireless communication system, the second base station comprising:
a transceiver; and
a controller coupled with the transceiver and configured to:
receive, from a first base station supporting an anchor carrier, a message including identification information for a terminal and coverage information for the data carrier, wherein the message is based on location related information for the terminal, and
identify whether to switch on or switch off the data carrier for network energy saving based on the message.

17. The second base station of claim 16, wherein the second base station does not transmit a synchronization signal and physical broadcast channel block (SSB) on the data carrier, and
wherein the coverage information includes power offset information for determining a power for a downlink transmission on the data carrier, the downlink transmission including at least one of a channel state information reference signal (CSI-RS) or a physical downlink shared channel (PDSCH).

18. The second base station of claim 16, wherein the location related information includes distance information and direction information for the access carrier, and
wherein the location related information is based on physical random access channel (PRACH) transmissions from the terminal, synchronization signal and physical broadcast channel block (SSB) reference signal received power (RSRP) reports from the terminal during an initial access, or SSB reports from the terminal in a radio resource control (RRC) connected state.

19. The second base station of claim 16, wherein the location related information includes position information for the access carrier, and
wherein the position information includes global positioning system (GPS) information, positioning reference signal (PRS) based coordination information from the terminal, or PRS based coordination information from a location management function (LMF) entity.

20. The second base station of claim 16, wherein the controller is further configured to:
transmit, to the first base station supporting the anchor carrier, a request for a data carrier change, and
receive, from the first base station supporting the anchor carrier, a response for the data carrier change.
